(19) United States
(12) Patent Application Publication
(10) Pub. No.: US 2008/0107619 A1
(43) Pub. Date: May 8, 2008

(54) Carbohydrate based cellulase inhibitors as feeding stimulants in termites

(75) Inventors: Michael E. Scharf, Gainesville, FL (US); Xuguo Zhou, High Springs, FL (US); Faith M. Oi, Gainesville, FL (US); Marsha M. Wheeler, Gainesville, FL (US)

Correspondence Address: LAW OFFICES OF BRIAN S STEINBERGER, 101 BREVARD AVENUE, COCOA, FL, 32922, US

(73) Assignee: University of Florida Research Foundation, Inc., Gainesville, FL (US)

(21) Appl. No.: 11/975,314

(22) Filed: Oct. 18, 2007

Related U.S. Application Data
(60) Provisional application No. 60/856,964, filed on Nov. 6, 2006.

(51) Int. Cl. A01N 43/16; A01N 33/18; A01N 43/50

(52) U.S. Cl. 424/84

(57) ABSTRACT

A method, composition and system for controlling termites wherein single carbohydrate-based compounds are used as both cellulase inhibitors and feeding stimulants. Di-saccharides, cellobioimidazole (CBI), fluoro-methyl cellobiose (FMCB), and mono-saccharides, fluoro-methyl glucose (FMG) and analogs thereof inhibit termite cellulose digestion, which leads to starvation or stimulates termite feeding to cause mortality. CBI, FMCB and FMG were tested against enzyme fractions that represented endogenous (foregut/salivary gland/midgut) and symbiotic (hindgut) termite cellulases in vitro and in vivo. Feeding stimulation by di-saccharides results in greater cellulase inhibitor intake throughout midrange concentrations (1 mM-10 mM), which is associated with significant termite mortality. In contrast, the monosaccharide inhibitor, FMG did not stimulate feeding, but did inhibit feeding at concentrations above 1 mM, causing mortality. With modification to create longer β-glycosidic chain lengths, the cellulase inhibitors identified herein can also be targeted to endoglucanase activity for increased efficacy and use as novel termite control compositions.

This invention claims the benefit of priority from U.S. Provisional Application Ser. No. 60/856,964 filed Nov. 6, 2006.

### FIELD OF THE INVENTION

This invention relates to a method, composition and system for the control of termites, and more particularly, to the use of carbohydrate-based compounds as termiticides, cellulase inhibitors and feeding stimulants using in vitro biochemistry and in vivo feeding assays.

### BACKGROUND OF THE INVENTION

Subterranean termites are the most common and economically devastating wood-destroying organisms in the United States and are considered by many experts to be the most frequently found wood-destroying insects in buildings throughout the world.

Termites are social insects that live in colonies where labor is divided among a caste system. All members of a colony are related, originating from a single founding pair. Within the caste system there are three distinct types of individual termites: reproductives (kings and queens), soldiers and workers.

Reproductives are sexually mature males and females and are responsible for producing offspring and establishing new colonies (swarming). Soldiers defend the colony and are terminally developed forms. Soldiers and workers are sterile and have no reproductive function.

Workers make up the largest portion of the termite colony and have a four-pronged mission: find wood, eat wood, feed the colony, and tend the colony. Such a mission is good for the forest and the ecosystem where the eating of wood and plant material helps in maintaining a balance between the living and dead organic matter, but bad for manmade buildings and structures, such as fences, paper, furniture, cloth and books that can be devoured over a period of time until the structural materials are severely damaged.

The worker termite tunnels tens to hundreds of feet from its underground colony through the soil to any source of water and cellulose and close relatives hemicellulose and lignin (hereinafter referred to as “cellulose”), which is devoured from the inside out. The worker termite actually eats the cellulose, communicates information related to sources of food from one termite to another by chemical odor (pheromones) and touch (tactile) communication. Workers also carry food from its source back to the colony where it is shared with other colony members by trophallaxis.

Worker termites require collaboration by several types of digestive cellulases in order to hydrolyze the cellulose in the wood they ingest as food. The digestive cellulases are synthesized by the termite's own ventricular cells, and by microorganisms present in the gut of the termite. For example, the hindgut of the Formosan subterranean termite, Coptotermes formosanus, contains a cellulase-producing protozoan species which hydrolyzes the cellulose in wood anaerobically via glucose to acetic acid which is then available to the termite for energy production and for lipid synthesis. Without cellulase-producing protozoa, the lower termites are incapable of digesting sufficient quantities of sound wood to survive.

Termites are important economic pests on a global scale, causing greater than $20 billion (US) annually in damage, control, and repair costs worldwide, according to N. Y. Su in “Novel technologies for Subterranean Termite Control. Sociobiology 40 (2002) 95-101. Subterranean termites from the genera Reticulitermes and Coptotermes are among the most economically important species worldwide. The two most effective control options for subterranean termites are soil treatment and baiting, as discussed by N. Y. Su et al in “Termites as Pests of Buildings, in Termites: Evolution, Sociality, Symbioses, Ecology T. Abe et al Eds., Kluwer Academic, Boston, 2000, pages 437-453. Soil treatments are typically made with large volumes of liquid termiticides that are either neurotoxins or inhibitors of mitochondrial respiration. Baiting, on the other hand, involves recruiting termites to feed on substrates impregnated with a slow-acting chemical insecticide. Both approaches have drawbacks; for example, soil termiticides raise many environmental concerns, while baits do not immediately reduce termite populations. In this respect, there is a need for faster-acting bait active ingredients with good environmental characteristics and broad-spectrum termite activity.

M. Ohkuma, in “Termite Symbiotic Systems: Efficient Bio-recycling of Lignocellulose,” Appl. Microbiol. Biotechnol. 61 (2003) 1-9 classifies termites as economic pests because of their unique ability to digest cellulose; however, for the same reason they are also considered ecologically beneficial. Termites accomplish cellulose digestion through the collaboration of three types of cellulases, namely endoglucanases (EC 3.2.1.4), exoglucanases (EC 3.2.1.91), and β-glucosidases (EC 3.2.1.21) according to J. A. Breznak et al. in “Role of microorganisms in the digestion of lignocellulose by Termites” Ann. Rev. Entomol. 39 (1994) 453-487. Through the actions of these three enzymes, lower termites such as the Reticulitermes are able to convert cellulose and its close relatives to monosaccharides with near 100% efficiency as reported by T. Inoue, et al in “Cellulose and Xylan Utilisation in the Lower Termite Reticulitermes speratus,” J. Insect Physiol. 43 (1997) 235-242. Cellulases in termites have both endogenous and symbiotic origins according to J. A. Breznak, supra and H. Watanabe in “A Cellulase Gene of Termite Origin,” Nature 394 (1998) 330-331, where “endogenous” refers to enzymes encoded by genes in the termite genome and “symbiotic” refers to enzymes produced by hindgut symbionts. While substantial research efforts have been directed toward discovery and characterization of termite cellulases, disproportionately little effort has gone toward investigating cellulases as a target for novel termite control agents.

The scientific knowledge gathered with regard to termites, their society and bodily functions is utilized today, particularly in the development of methods and compositions for termite control. In the first research of its kind on termite cellulase inhibition, Zhu et al. in “Screening Method for Inhibitors against Formosan Subterranean Termite β-glucosidases in vivo, in J. Econ. Entomol. 98 (2005) 41-46 observed moderate inhibition of Coptotermes formosanus cellulases in vivo by various carbohydrate-based and non-carbohydrate-based inhibitors.

With the ever-pressing demand for termite control compositions that are environmentally safe and effective in preventing termite infestation, researchers are pursuing a number of strategies to overcome problems of prior compositions.

Among the various methods and compositions reported in the patent literature are the following.

U.S. Pat. No. 6,352,703 and the corresponding European patent WO 1999/29,172 to University of Louisiana State disclose compositions and methods for detecting and killing termites using significant concentrations of naphthalene in carton nests of Formosan subterranean termites, Coptotermes formosanus Shiraki, collected from Florida, Hawaii, and Louisiana. This is the first report of naphthalene being associated with termites or any other insects.

U.S. Pat. Nos. 6,316,017 and 6,306,416 are both U.S. Department of Agriculture patents that disclose a composition and apparatus that is applied to a solid substrate to produce an article of manufacture which is both attractive and toxic to insect pests and therefore useful for insect control.

U.S. Pat. No. 6,203,811 discloses termite control compositions that are considered termite phagostimulatory compositions extracted from fungi coexisting with subterranean termites. The termite control strategy is to deter subterranean termites from colonizing or feeding on particular substrates and structures.

U.S. Pat. No. 5,756,114 discloses a method and composition for termite control including a pesticide that is toxic to a termite's gut-dwelling cellulase-producing protozoa. The pesticide is present at an effective pesticidal and non-feeding-deterrent concentration.

U.S. Pat. No. 4,510,133 provides a method for combating pests with insecticidally active compositions comprising a combination of a C-076 or B-41 macrolide antibiotic with an insect feeding stimulant.

U.S. patent Publications also disclose methods and compositions for use as feeding stimulants to lead to the death of termites.

Two patents assigned to the National Aeronautics Space Administration (NASA), U.S. Patent Publ. 2005/042,246 and WO 2002/056,684 use urea and nitrogen based compounds as feeding stimulants/aggregants and masking agents of unpalatable chemicals for subterranean termites; the masking agents conceal the presence of other compounds which are repellents to termites, when they are used in low concentrations, less than or equal to about 1000 ppm (0.1%, by weight).

U.S. Patent Publ. 2005/031,581 describes a termite feeding stimulant and a method for using the same including a sitosterol containing formulation useful for increasing feeding or inducing phagostimulatory responses by termites, and in particular the following species of termites: Coptotermes formosanus, Reticulitermes tibialis, Reticulitermes flavipes, and Reticulitermes virginicus.

The following European patents have addressed methods and compositions for termite control. WO 2005/092,029 discusses how termite behavior can be manipulated by providing food sources more attractive to them than their otherwise available food resources. Inulins, levans, fructans, and other 13-linked carbohydrates that are smaller than cellulose serve as termite feeding attractants/stimulants, especially for subterranean termites.

WO 2004/093,538 provides a long lasting insect baiting system containing wax (e.g., paraffin, GulfWax), a hardener (e.g., Elvax-60), an emulsifier (e.g., SPAN 60), an oil (e.g., food oils (preferably related to insect feeding) such as corn oil, molasses, glycerol or corn syrup), a chemical attractant (e.g., ammonium acetate or carbonate) and a phagostimulant (e.g., food such as proteinaceous materials such as protein and hydrolyzed protein or feeding stimulant, such as sugars like sucrose), optionally a visual attractant (e.g., food coloring), and optionally a toxicant (e.g., avermectin, methomyl, spinosad, phloxine B).

Japanese Patent 2004/051,507 describes a feeding stimulant composition comprising an oligosaccharide and an amino acid as active ingredients. The amino acid is characterized by at least one kind selected from aspartic acid, threonine, serine, asparagine, glutamic acid, glutamine, methionine, isoleucine, leucine, tyrosine, phenylalanine, lysine, histidine, arginine and proline. The oligosaccharide is characterized by comprising D-glucose as a constituent monosaccharide.

WO 2003/105,580 to University of Florida describes devices, kits, and methods for eliminating termite colonies. The kits, devices, and methods employ a termiticidal bait matrix containing a) a termiticide selected such that the termiticide causes death to from about 50% to about 100% of termites within about 24 to about 84 days after the termites begin to ingest the termiticide or the bait matrix comprising the termiticide, b) a cellulose containing material, and c) water. The termiticidal bait matrix can be used in a bait station installed in the ground. The kits are suitable to be used by consumers in their homes.

Japanese Patent 2003/252,710 describes a stomach poison for termites comprising bistrifluoron (N-(2-chloro-3,5-bis(trifluoromethyl)phenyl)-N′-(2,6-difluorobenzoyl)urea) (hereinafter referred to as the compound). When the stomach poison for the termites is orally administered to the termites, the stomach poison is found to have moderate slow-acting properties and high insecticidal power. The feeding properties of the termites are found to improve and exhibit high controlling effects by including the stomach poison for the termites in bait stations.

WO 2003/039,250 to University of Colorado Research discloses a termite feeding stimulant and a method for using the same including a sitosterol containing formulation useful for increasing feeding or inducing phagostimulatory responses by particular species of termites, including Reticulitermes tibialis.

WO 2000/036,914 to J. Reinhard, et al. describes a feeding stimulant for stimulating feeding activity in termites, comprising a compound having at least two OR groups, each of which is a substituent of an aryl moiety, and R is hydrogen or an organic group, and addition compounds thereof.

WO 2000/028,824 to Aventis Crop Science SA discloses compositions and methods for controlling the population of insects. The compositions include a feeding stimulant for a particular insect, an effective amount of a 1-arylpyrazole or nicotinyl insecticide to kill a desired insect, at a concentration which is not typically toxic when applied to a plant in the absence of a feeding stimulant and the insect consumes an ordinary amount of toxin during the course of normal feeding, but is toxic when applied in conjunction with a feeding stimulant which causes the insect to consume more of the toxin than would normally be consumed during normal feeding. The use of normally non-toxic amounts of insecticides allows one to minimize the residual insecticide present on the crops

European Patent 0563963 assigned to Agrisense describes an enhanced delivery system for insecticides which utilizes novel insect feeding stimulant compositions. These compositions consist essentially of: (a) a yeast selected from the group consisting of Candida utilis, Pichia pastoris and Kluvomyces fragilis; (b) a flour selected from the group consisting of: cotton seed flour, soybean flour, rice flour, wheat flour and rape seed (canola); and (c) a sugar source selected from the group consisting of sucrose, fructose and glucose.

WO 1992/11,856 describes a novel and useful biopesticide with activity against insect pests such as boll weevil, sweet potato whitefly and cotton leafhopper. The biopesticide of the subject invention comprises an entomopathogenic fungus having virulence against a targeted insect pest(s), an arrestant and feeding stimulant for the targeted insect pest(s) and, optionally, a pheromone for the targeted insect pest(s). A preferred fungus is a Beauveria bassiana, preferably Beauveria bassiana, ATCC-74040 (ARSEF-3097).

At the 2001 Annual Meeting of the Entomological Society of America a paper entitled, “Termite feeding stimulants for Reticulitermes tibialis isolated from preferred wood” by David James et al. (Paper Withdrawn at Conference). The abstract can be accessed at website: (http://esa.confex.com/esa/2001/techprogram/paper_{—}2412.htm). The printed abstract refers to the fact that termites prefer to feed on wood from certain tree species more than others. Feeding stimulants in the wood might account for this preference and extracts of termite-preferred wood were shown to stimulate feeding.

In addition to the scientific paper by Zhu et al. J. Econ. Entomol. 98 (2005) 41-46 supra, which identified cellulase inhibitors as a potential target site for novel and more environmentally friendly termite-specific insecticides, the following references discuss the use of cellobioimidazole (CBI) as an inhibitor of cellobiohydrolases in yeast and an inhibitor of endoglucanases in a bacterium.

Vonhoff et al. in “Inhibition of Cellobiohydrolases from Trichoderma reesei. Synthesis and evaluation of some glucose-, cellobiose-, and cellotriose-derived hydroximolactams and imidazoles.” Helv. Chim. Acta 82 (1999) 963-980, investigated a number of inhibitors including CBI against the Cel7A and 6A cellobiohydrolases (exoglucanases) of the yeast, Trichoderma reesei. They determined that CBI non-competitively inhibited the two cellobiohydrolases, with I₅₀s of 130 μM and 1 μM for Cel7A and 6A, respectively.

Varrott et al. in “Lateral protonation of a glucosidase inhibitor: structure of the Bacillus agaradhaerens Cel5A in complex with a cellobiose-derived imidazole at 0.97 Å resolution.” J. Am. Chem. Soc. 121 (1999) 2621-2622. investigated CBI inhibition of endoglucanase activity by the Cel5A enzyme of the bacterium, Bacillus agaradhaerens. (I₅₀ value of 88 μM). The I₅₀ concentrations are significantly high.

Zhu et al. supra examined five prototype β-glucosidase inhibitors after feeding in a prototype enzyme activity assay. Only one inhibitor was found completely ineffective (sinapinic acid) while four others (conduritol-β-epoxide, 1-deoxynojirimycin, ferulic acid and gluconolactone) provided between 27 and 65% inhibition. Two of these inhibitors, 1-deoxynojirimycin and gluconolactone, are carbohydrate-based compounds.

Several references examined carbohydrate feeding preferences in Reticulitermes termites. J. Reinhard et al. in “Thin-layer chromatography assessing feeding stimulation by labial gland secretion compared to synthetic chemicals in the subterranean termite Reticulitermes santonensis,” J. Chem. Ecol. 27 (2001) 175-87 used thin-layer chromatography (TLC) to investigate feeding on a number of chemicals including sugars in R. santonensis, the European synonym of R. flavipes. These investigators observed that several alpha sugars (glucose, fructose, arabinose and sucrose), but not the beta-linked disaccharide cellobiose, co-migrated with phagostimulatory labial [salivary] gland secretions on cellulose TLC plates. However, the major phagostimulatory component of the labial gland secretion was later determined not to be a carbohydrate, but rather a quinone. See J. Reinhard, et al. in “Hydroquinone: a general phagostimulating pheromone in termites,” J. Chem. Ecol. 27 (2002) 175-187.

D. A. Waller, et al. in “Effects of sugar-treated foods on preference and nitrogen fixation in Reticulitermes flavipes and Reticulitermes virginicus,” Ann. Entomol. Soc. Am. 96 (2003) 81-85, found that R. flavipes and R. virginicus both consumed more paper substrates treated with glucose, sucrose and xylose than untreated controls in choice tests. Likewise, R. K. Saran, et al. in “Feeding, uptake, and utilization of carbohydrates by western subterranean termite,” J. Econ. Entomol. 98 (2005) 1284-1293, reported that the western subterranean termite R. hesperus consumed significantly more paper that was treated with a number of mono-, di- and polysaccharides relative to untreated controls. Saran et al. also compared simple and multiple choice feeding assays and observed essentially the same effects.

U.S. Pat. Nos. 7,157,078; 7,030,156; 6,969,512; 6,964,124; 6,716,421 to Brode, III et al., assigned to the University of Florida Research Foundation, Inc., the same assignee as the subject invention describe specific organic compounds as termiticides and cellulase inhibitors. At all times, the Brode, III et al. patents require feeding stimulants must be separate and additional materials. The Brode III, et al patents describe the use of feeding stimulants as covering separate materials, such as ergosterol, fermented milk, fluoroglucinol, and preferably hydroquinone, that must be separately added to other compounds. Currently the termite industry is required to add and mix different materials that results in extra time, labor and material costs.

Thus, there are many scientific approaches to controlling termite infestation. The use of baits for termite control has grown in popularity due to increased environmental awareness and the banning of available termiticides, but bait acceptance by termites remains a limiting factor. There is a need for termite bait that is stable, highly attractive, phatostimulatory, non-toxic and less complex than existing products. In addition, the termite bait must not be rejected by the worker termite and reliable as a killer. Previously developed methods and compositions fall short in these regards.

The subject inventors have discovered carbohydrate-based cellulase-inhibiting termiticides and feeding stimulants that overcome the shortfalls of the prior art.

### SUMMARY OF THE INVENTION

The invention described herein relates to a method, composition and system for controlling termites that uses mono- and di-saccharide sugars to increase feeding rates and termite mortality.

It is a primary objective of the present invention to develop a method, composition and system for controlling termites using a termite bait system that is non-toxic to the environment and is useful as both a cellulase inhibitor and a feeding stimulant in one compound.

A secondary objective of the present invention is to develop a method, composition and system for controlling termites using a carbohydrate-based cellulase inhibitor as both a termiticide and a feeding stimulant.

A third objective of the present invention is to provide a method, composition and system for controlling termites using a carbohydrate-based cellulase inhibitor as a feeding stimulant in termites.

A fourth objective of the present invention is to provide a method, composition and system for controlling termites that incorporate structural constructs of carbohydrate-based cellulase inhibitors as feeding stimulants in termites.

A fifth objective of the present invention is to provide a method, composition and system for controlling termites using a carbohydrate-based cellulase inhibitor that effectively inhibits termite cellulose digestion and does not require additional feeding stimulants.

A sixth objective of the present invention is to provide a method, composition and system for controlling termites using a carbohydrate-based compound consisting solely of mono- and di-saccharide sugars, as a feeding stimulant for termites.

In the present invention, novel carbohydrate-based cellulase inhibitor compounds, cellobioimidazole (CBI), fluoromethyl cellobiose (FMCB) and fluoromethyl glucose (FMG) and analogs thereof were used against R. flavipes. The performance of each carbohydrate-based compound as a novel cellulase-inhibiting termiticide and as feeding stimulants are discussed in detail below.

A preferred carbohydrate-based cellulase inhibitor composition includes mono-saccharide sugars in an effective amount to affect feeding rates in termites. The more preferred mono-saccharide sugars are fluoro-methyl-glucose (FMG), mono-fluoro glucose, and di-fluoro glucose and analogs thereof. The preferred effective amount of fluoro-methyl-glucose (FMG) is in a concentration above approximately 1 mM to inhibit feeding and cause significant termite mortality at the lowest and highest concentrations.

Another preferred carbohydrate-based cellulase inhibitor composition includes di-saccharide sugars in an effective amount to affect feeding rates in termites. The more preferred di-saccharide sugars are fluoro-methyl cellobiose (FMCB), cello-bio-imidazole (CBI), and cellobio-dintrophenol and analogs thereof. The effective amount of cello-bio-imidazole (CBI) is in a range between approximately 1 mm to approximately 10 mM to cause sufficient feeding stimulation of termites to result in termite mortality. The effective amount of fluoro-methyl cello biose (FMCB) is in a range between approximately 1 nM to approximately 10 mM to cause sufficient feeding stimulation of termites to result in termite mortality.

A preferred environmentally non-toxic termite bait system contains mono-saccharide sugars in an amount effective to affect feeding rates in termites. The more preferred mono-saccharide sugars are fluoro-methyl-glucose (FMG), mono-fluoro glucose, and di-fluoro glucose. The effective amount of fluoro-methyl-glucose (FMG) is in a concentration above approximately 1 mM to inhibit feeding and cause significant termite mortality at the lowest and highest concentrations.

Another preferred environmentally non-toxic termite bait system contains di-saccharide sugars in an amount effective to affect feeding rates in termites. The more preferred di-saccharide sugars are fluoro-methyl cello biose (FMCB), cello-bio-imidazole (CBI), and cellobiose-dintrophenol (cellobio-DNP). An effective amount of cello-bio-imidazole (CBI) is in a range between approximately 1 mM to approximately 10 mM to cause sufficient feeding stimulation of termites to result in termite mortality.

An effective amount of fluoro-methyl cello biose (FMCB) is in a range between approximately 1 mM to approximately 10 mM to cause sufficient feeding stimulation of termites to result in termite mortality.

A preferred termite bait composition is disclosed that is non-toxic to the environment and consists of a single carbohydrate-based compound used as a termiticide and a cellulase inhibitor and as a feeding stimulant, wherein no separate materials are used with the compound.

The more preferred carbohydrate-based compound is an analog of at least one of fluoro-methyl-glucose (FMG), mono-fluoro glucose, di-fluoro glucose, fluoro-methyl cellobiose (FMCB), cello-bio-imidazole (CBI), and cellobio-dintrophenol and a preferred amount is in a range of between approximately 1 mM to approximately 10 mM to result in termite mortality.

It is also preferred that the carbohydrate-based compound is an analog which consists of a long cellulose chain, preferably, including β-glycosidic chain lengths.

A preferred method for controlling termites by both inhibiting cellulose digestion and stimulating termite feeding, can include the steps of selecting a termite food source having an effective amount of a composition consisting of a single mono-saccharide sugar compound selected from the group consisting of fluoro-methyl-glucose (FMG), mono-fluoro glucose, and di-fluoro glucose, baiting termites with the selected termite food source, stimulating termite feeding solely with the selected termite food source, and inhibiting cellulase digestion of the termites solely with the selected termite food source, wherein the selected termite food source is used for controlling the termites.

The baiting step can include incorporating the selected termite food source as the sole termiticide in a termite bait station. The selected termite food source is preferably in a range between approximately 1 mM to approximately 10 mM.

Further objects and advantages of this invention will be apparent from the following detailed descriptions of presently preferred embodiments which are illustrated schematically in the accompanying drawings.

### BRIEF DESCRIPTION OF THE FIGURES

FIG. 1A is the chemical structure of carboxymethyl cellulose (CMC) used to test for termite endoglucanase activity in the present invention.

FIG. 1B is the chemical structure of p-Nitrophenyl β-D-cellobioside (pNPC) used to test for termite exoglucanase activity in the present invention.

FIG. 1C is the chemical structure of p-Nitrophenyl β-D-glucopyranoside (pNPG) used to test for termite β-glucosidase activity in the present invention.

FIG. 1D is the chemical structure of cellobio-imidazole (CBI) used as a novel carbohydrate-based termite cellulase inhibitor in the present invention.

FIG. 1E is the chemical structure of fluoromethyl glucose (FMG) used as a novel carbohydrate-based termite cellulase inhibitor in the present invention.

FIG. 1F is the chemical structure of fluoromethyl cellobiose (FMCB) used as a novel carbohydrate-based termite cellulase inhibitor in the present invention.

FIG. 2A identifies in vitro optimal assay conditions for CMC based endoglucanase activity when CMC concentration is 0.5% weight/volume.

FIG. 2B identifies in vitro optimal assay conditions for CMC based endoglucanase activity when protein concentrations are in the range of 0.5 to 1.5 mg/ml.

FIG. 2C identifies in vitro optimal assay conditions for CMC based endoglucanase activity when assay time is 30 minutes.

FIG. 2D identifies in vitro optimal assay conditions for CMC based endoglucanase activity when the homogenization buffer has a pH of 5.8.

FIG. 2E identifies in vitro optimal assay conditions for CMC based endoglucanase activity when the assay temperature is 32° C.

FIG. 2F shows in vitro the linear activity ranges of denatured protein and active protein during cellulase activity assay conditions.

FIG. 3A identifies in vitro optimal assay conditions for pNPG based beta-glucosidase activity and pNPC based exoglucanase activity when substrate concentrations are 4 mM.

FIG. 3B identifies in vitro optimal assay conditions for pNPG based beta-glucosidase activity and pNPC based exoglucanase activity when protein concentration is in the range of 0.5 to 1.5 mg/ml.

FIG. 3C identifies in vitro optimal assay conditions for pNPG based beta-glucosidase activity and pNPC based exoglucanase activity when the assay time is 60 minutes.

FIG. 3D identifies in vitro optimal assay conditions for pNPG based beta-glucosidase activity and pNPC based exoglucanase activity when the homogenization buffer has a pH of 5.8.

FIG. 4 shows the 150 of FMG, FMCB and CBI in vitro on endoglucanase, exoglucanase and beta-glucosidase activities in the foregut and hindgut sections across the nanomolar to molar range.

FIG. 5 shows the configuration used for experimental Petri dish in vivo feeding bioassays with worker termites.

FIG. 6 shows results of termite feeding on filter paper disks.

FIG. 7A is a graph of in vivo concentration-associated feeding impact of the FMG cellulase inhibitor of the present invention.

FIG. 7B is a graph of in vivo concentration-associated feeding impact of the FMCB cellulase inhibitor of the present invention.

FIG. 7C is a graph of in vivo concentration-associated feeding impact of the CBI cellulase inhibitor of the present invention.

FIG. 7D is a graph of mortality results after 24 days of in vivo feeding on the FMG cellulase inhibitor of the present invention.

FIG. 7E is a graph of mortality results after 24 days of in vivo feeding on the FMCB cellulase inhibitor of the present invention.

FIG. 7F is a graph of mortality results after 24 days of in vivo feeding on the CBI cellulase inhibitor of the present invention.

FIG. 8A shows cumulative average feeding, calculated relative to untreated controls for feeding stimulant, fluoro-methyl-glucose (FMG), at various concentrations.

FIG. 8B shows cumulative average feeding, calculated relative to untreated controls for feeding stimulant, cello-bio-imidazole (CBI), at various concentrations.

FIG. 9 is a graph comparing in vivo feeding on fluoro-methyl-glucose (FMG) and cello-bioimidazole (CBI) for 24 days, at various concentrations.

FIG. 10A shows average cumulative mortality for fluoro-methyl-glucose (FMG) after 24 days in in vivo feeding bioassays.

FIG. 10B shows average cumulative mortality for cello-bio-imidazole (CBI) after 24 days in in vivo feeding bioassays.

FIG. 11A shows the reduction in endoglucanase, exoglucanase and β-glucosidase activities after in vivo feeding on various concentrations of FMG.

FIG. 11B shows the reduction in endoglucanase, exoglucanase and β-glucosidase activities after in vivo feeding on various concentrations of FMCB.

FIG. 11C shows the reduction in endoglucanase, exoglucanase and β-glucosidase activities after in vivo feeding on various concentrations of CBI.

FIG. 12A is a graph of in vivo feeding stimulation using monosaccharide glucose and the di-saccharides, maltose and cellobiose with the mono and di-saccharides in various concentrations.

FIG. 12B shows termite mortality after in vivo feeding assays with the monosaccharide glucose and the disaccharides, maltose and cellobiose with the mono and di-saccharides in various concentrations.

FIG. 13 shows a comparison of mortality of laboratory colony and field colony termites after in vivo feeding with FMG, at various concentrations.

### DESCRIPTION OF THE PREFERRED EMBODIMENT

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

All percentages, ratios and proportions used herein are by weight unless otherwise specified.

It would be useful to discuss the meanings of some words used herein and their applications before discussing the carbohydrate-based cellulase inhibitors as feeding stimulants in termites.

“Attractant” means a compound that stimulates foraging termites to locate and/or feed on compositions containing the compound over other compositions and/or their regular food source.

“Cellulase” means a member of a class of enzymes that digest cellulose into glucose. Cellulase is a general term for a family of enzymes which act in concert to hydrolyze cellulose and together make up the cellulase complex.

“Cellulase complex” means a natural enzyme mix of multiple exoglucanases, endoglucanases, and β-glucosidase as well as other enzymes produced by most organisms that produce cellulases.

“Cellulase inhibitor” means a compound, alone or in combination, that prevents one or more of the cellulases in the gut of a termite from digesting cellulose, at least to some degree, e.g., a degree sufficient to kill the termite. Preferred cellulase inhibitors are specific to cellulases, i.e., they do not inhibit or change the action of many proteins other than cellulases. More preferred cellulase inhibitors do not inhibit or change the action of proteins found in animals other than termites, particularly humans. Most preferred cellulase inhibitors, for purposes of this invention, do not inhibit or change the action of any proteins other than cellulases.

“Feeding stimulant” means a compound that affects the feeding rate of a termite by increasing the amount that termites eat of compositions containing the compound over other compositions and/or their regular food source.

I₅₀ expresses the concentration of inhibitor that decreases the rate of an enzyme catalyzed reaction by fifty percent (50%).

“Trophallaxis” means transfer of gut content or food from a termite to other colony members.

The present invention provides a novel approach to the control and elimination of wood-destroying insects, such as termites. Mono-saccharides, di-saccharides and novel carbohydrate-based cellulase inhibitors disclosed herein are non-toxic to the environment and yet affect the feeding rates of termites to the extent that death is caused and termite infestations are controlled.

Although wood is highly abundant and is carbohydrate rich, nutritionally it is considered a poor food source because much of its mass is made up of the fibrous polysaccharide cellulose. Cellulose is composed of long sugar chains, which are linked together by β(1-4) glycosidic bonds. This chemical structure makes cellulose an extremely rigid molecule and it cannot be digested without the presence of specialized enzymes called cellulases. Cellulases are capable of hydrolyzing glycosidic linkages of cellulose and degrading it into the universal energy source, glucose.

Termites are one of the most well known organisms to have evolved specialized feeding habits and can subsist almost entirely on wood. They are considered the most efficient cellulose-digesters. Also, lower termite species (including Reticulitermes) are associated with symbiotic protozoa that produce additional cellulase enzymes. Termites thrive in a variety of ecosystems worldwide and play an important role in the biorecycling of plant material. However, their affinity for sound and decaying wood is also the reason why they are considered major structural pests.

Procter & Gamble (P & G) has developed several carbohydrate-based cellulase inhibitors as an alternative method for termite control. The efficacy of three of these carbohydrate-based cellulase inhibitors against termites is the subject of the present invention.

The subject inventors discovered that mono- and di-saccharide compounds disclosed herein have an additional use as feeding stimulants which was unknown to Proctor and Gamble, the originator of U.S. Pat. Nos. 7,157,078; 7,030,156; 6,969,512; 6,964,124; 6,716,421 to Brode III et al. which have now been assigned to the University of Florida Research Foundation, Inc., the same assignee as the subject invention. The definition of a “feeding stimulant” and “cellulase inhibitor” is given earlier in the lexicon of words just below the Description of the Preferred Embodiment of the present invention. The Brode, III et al. patents require that a termiticide and cellulase inhibitor must use separate and additional materials as feeding stimulants. For example, the Brode III, et al patents require additional feeding stimulants, such as ergosterol, fermented milk, fluoroglucinol, and preferably hydroquinone, that must be separately added to other compounds. Requiring additional materials as feeding stimulants results in extra time, labor and material costs for controlling termites.

The economic benefit of finding the dual function of both feeding stimulant and cellulase inhibitor in one ingredient instead of a combination of materials represents significant savings in time, labor and materials for the termite control industry.

First, a discussion of materials and methods applicable to the studies conducted and discussed herein is provided.

### Termites.

R. flavipes colonies were collected from the University of Florida campus during spring and summer 2006. Colonies were maintained in sealed plastic boxes (30×24×10 cm) at 22±1° C. and 69±1% RH. Colonies were maintained without soil and provisioned with moist brown paper towels and wood shims. Colonies that were acclimated under the above conditions for <2 months are referred to as “field colonies”, while those held for >6 months are referred to as “lab colonies”. Unless otherwise stated, all studies reported here were run with lab colonies.

The identity of colonies as R. flavipes was made by a combination of soldier morphology as described by W. L. Nutting, Insecta: Isoptera, in: Soil biology guide, D. L. Dindal (Ed.), Wiley and Sons, New York, 1990, pp. 997-1032 and using a “DNA fingerprint,” PCR-RFLP based identification key as disclosed by A. L. Szalanski, et al. in “Identification of Reticulitermes spp. from South Central United States by PCR-RFLP,” J. Econ. Entomol. 96 (2003) 1514-1519.

Only worker termites are used because of their status as primary cellulose consumers and cellulase reservoirs in R. flavipes colonies according to M. E. Scharf, et al. in “Caste- and development-associated gene expression in a lower termite,” Genome Biol. 4[10] (2003) R62. [http://genomebiology.com/2003/4/10/R62], Termites were considered workers if they did not possess any sign of wing buds or distended abdomens, and had pronotal widths wider than mesonotal widths as disclosed by L. V. Lainé, et al. in “The life cycle of Reticulitermes spp.: what do we know?” Bull. Entomol. Res. 93 (2003) 267-278.

### Chemicals.

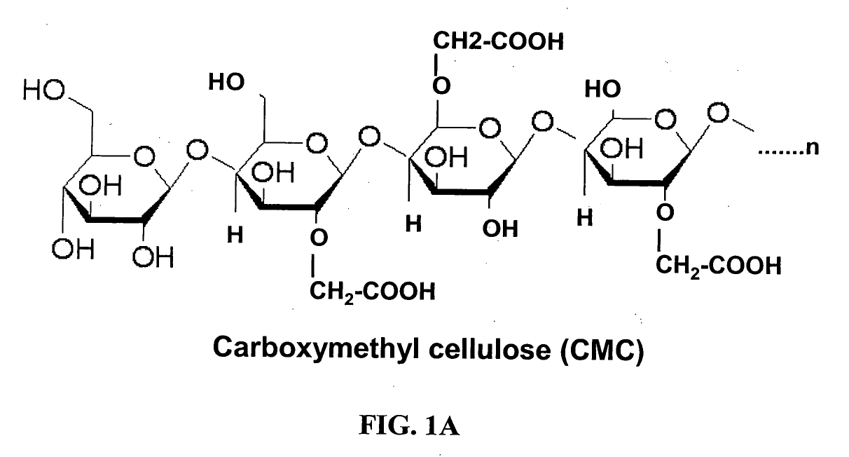

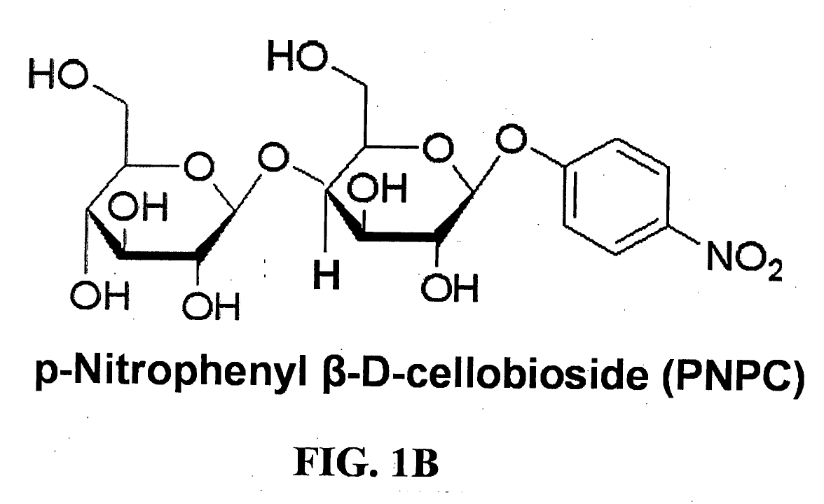

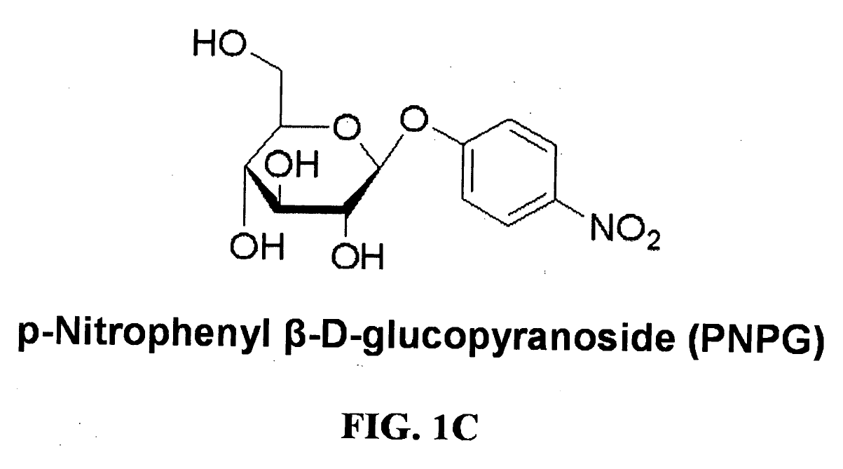

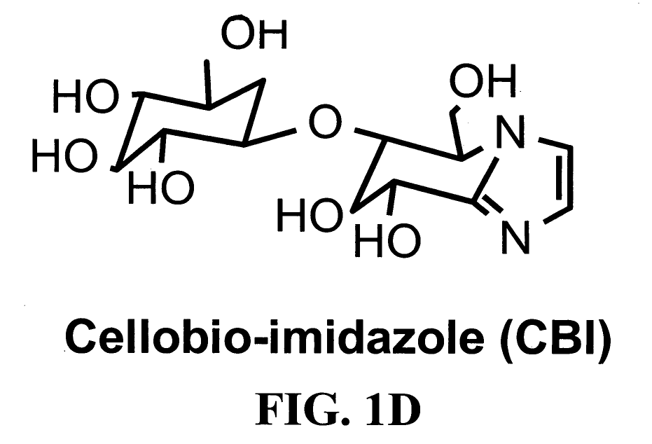

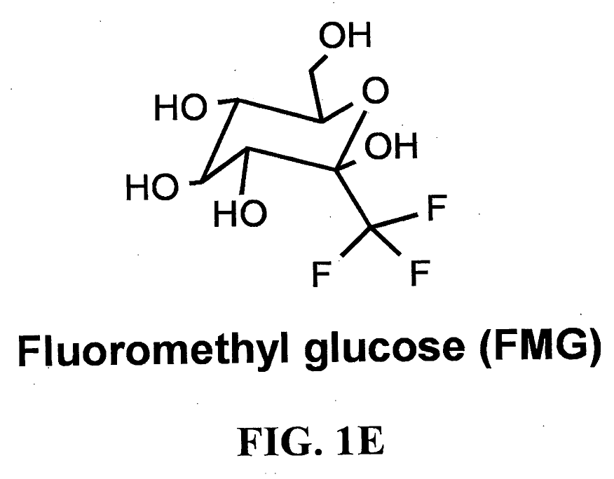

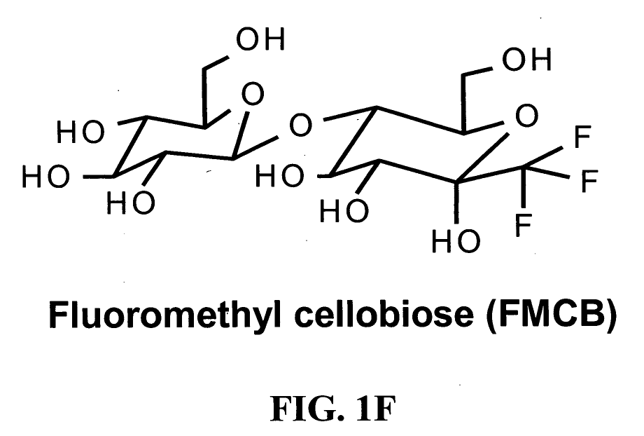

FIGS. 1A, 1B and 1C show the chemical structures of carboxymethyl cellulose (CMC), p-Nitrophenyl β-D-cellobioside (pNPC), p-Nitrophenyl β-D-glucopyranoside (pNPG), respectively. CMC, pNPC and pNPG are cellulase model substrates used to test for enzyme activity, namely, endoglucanase activity, exoglucanase activity and β-glucosidase activity respectively. FIGS. 1D, 1E and 1F are the chemical structures of novel, carbohydrate-based cellulase inhibitors of the present invention; namely, cellobioimidazole (CBI), fluoro-methyl glucose (FMG) and fluoro-methyl cellobiose (FMCB), respectively.

Cellobioimidazole (CBI; 95% purity), fluoromethyl glucose (FMG; 95% purity) and fluoromethyl cellobiose (FMCB; 95% purity) were obtained from Carbohydrate Synthesis Ltd. (Oxford, UK). All inhibitor stocks and dilutions were prepared in reagent-grade methanol (Sigma; St. Louis, Mo.).

The three substrates carboxymethyl cellulose (CMC), p-nitrophenyl cellobioside (pNPC), and p-nitrophenyl glucopyranoside (pNPG) were obtained from Sigma and diluted in methanol. The saccharides: dextrose (99%, Fisher Scientific; Suwanee, Ga.), maltose [90%, D(+)-monohydrate; Acros Organics; Suwanee, Ga.], and cellobiose [D(+), 98%; Acros Organics] were prepared as stock solutions in water due to limited solubility in methanol.

### Enzyme Preparation and Protein Assay.

Gut dissections were carried out for cellulase distribution and inhibition studies. For dissections, termites were immobilized on ice, decapitated, and the entire digestive tract removed through a small incision made in the abdominal exoskeleton. For cellulase distribution studies, dissected guts were divided into three regions: (i) salivary gland+foregut, (ii) midgut and (iii) hindgut. For inhibition studies, guts were divided into two major components that included: (i) foregut, salivary gland and midgut, and (ii) hindgut. For the various gut homogenates, 25 dissected gut regions were homogenized using a 2-ml Tenbroeck tissue grinder and homogenized manually in 1-ml of ice cold homogenization buffer (0.1 M sodium acetate, pH 5.8).

Whole body homogenates were used for optimization and post-feeding inhibition studies. Here, 10-15 termite workers were homogenized in 1 to 1.5 ml ice-cold homogenization buffer with a Teflon-glass (Potter-Elvehjem) homogenizer powered by a motorized electric stirrer (Fisher Scientific). After homogenization, both gut region and whole-body preparations were centrifuged at 15,000× g and 4° C. for 15 min. The resulting supernatants from the different gut regions were used directly for subsequent enzyme assays. Supernatants from whole-body homogenates were passed through glass wool to remove excess lipids before proceeding with cellulase activity assays.

Protein concentration was determined for protein preparations using a commercially available bicinchoninic acid assay (Pierce; Rockford, Ill.) with bovine serum albumin as a standard.

### Cellulase Activity Assays.

Cellulase activity assays were adapted from Han et al. in “Characterization of a bifunctional cellulase and its structural gene,” J. Biol. Chem. 270 (1995) 26012-26019, with optimization for a 96-well microplate format. The model substrates used to test for endoglucanase, exoglucanase and β-glucosidase activities were CMC (FIG. 1A), pNPC (FIG. 1B) and pNPG (FIG. 1C), respectively. The substrate concentration used for CMC was 0.5% (w/v), while pNPG and pNPC were used at 4 mM. All substrates were diluted in homogenization buffer. Reactions were initiated by the addition of 10 μl enzyme preparation to 90 μl substrate solution. The CMC assay was run as an endpoint assay in which reactions (in micro plates) were incubated at 32° C. for 30 min, and then terminated by the addition of 100 μl stop solution (1% 3,5 dinitrosalicylic acid [DNSA], 30% potassium tartrate, 0.4 M sodium hydroxide). The reaction was fixed by placing the plate in a 100° C. water bath for 10 min. Color was allowed to develop on ice for 15 min before measuring absorbance at 540 nm relative to a glucose standard curve.

The hydrolysis product of both the pNPC and pNPG substrates is p-nitrophenol, which is yellow in color and permits for direct quantification of activity in a kinetic assay. pNPC and pNPG assays were initially incubated at 32° C. for 20 min before measuring the release of the product, p-nitrophenol, at 420 nm. The absorbance of reactions was read every 2 min for 1 hr and activity was determined based on rate of absorbance change. An extinction coefficient (0.6605 mM/OD) was extrapolated from a p-nitrophenol standard curve. The path length (0.288 cm) was determined by the reaction volume (100 μl) and the physical properties and dimensions of a COStar® 96-well flat bottom assay plate (Corning Inc.; Corning, N.Y.).

### Optimal Assay Conditions.

The CMC assay is an endpoint assay, which allowed for testing of a broader range of conditions relative to the pNPC and pNPG assays, which are kinetic assays. A range of assay conditions examined in the CMC assay included substrate concentration [0.0625-2%], protein concentration [0.3125-40 termite/ml which is equivalent to 0.0331-3.2513 mg protein/ml], assay time (10-70 min), assay temperature (22-57° C.), and homogenization buffer pH (3.4-6.6). Also, the impact of residual glucose remaining in the gut on the CMC assay was investigated by comparing CMC hydrolysis activity with- and without denatured protein. The conditions tested for the kinetic pNPC and pNPG assays were substrate concentration [0.125-16 mM and 0.25-32 mM, respectively], protein concentration [0.3125-40 termite/ml which is equivalent to 0.0331-3.2513 mg protein/ml], assay time (10-70 min), and homogenization buffer pH (3.4-6.6).

### I₅₀ Determination.

The efficacy of the three carbohydrate-based cellulase inhibitors CBI (FIG. 1D), FMG (FIG. 1E) and FMCB (FIG. 1F) was tested against two different gut enzyme sources that included (i) endogenous termite cellulases from salivary gland, foregut and midgut, and (ii) symbiotic cellulases from the hindgut. For effective inhibitors, appropriate concentrations were identified and tested that yielded a 0-100% range of inhibition. Assays were initiated by the addition of 5 μl inhibitor (in methanol) in a 95-μl reaction that contained 10-μl enzyme preparation and 85 μl substrate solution. Percent inhibition was calculated relative to methanol controls. Using a range of inhibitor concentrations, inhibition curves were generated and used to determine 50% inhibition (i.e., 150) by linear regression and extrapolation. Each inhibition curve was derived from three independent preparations with three determinations for each concentration.

### Example 1

### Inhibition of Termite Cellulases by In Vitro Biochemistry

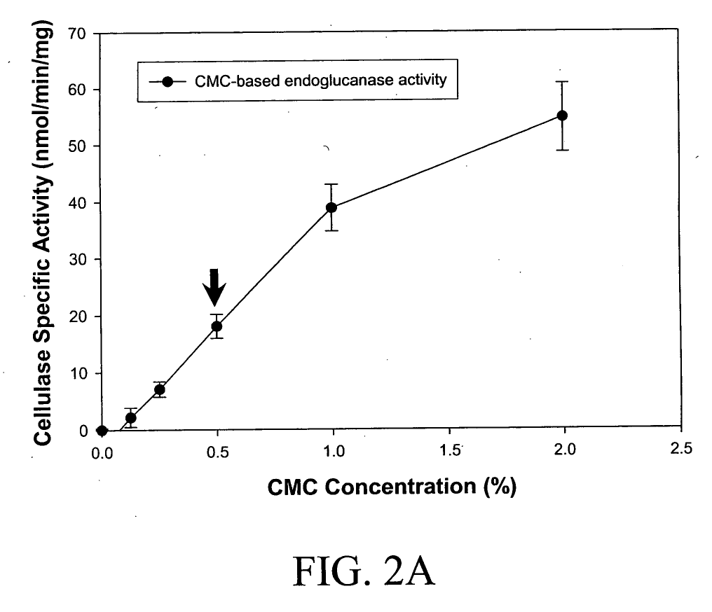

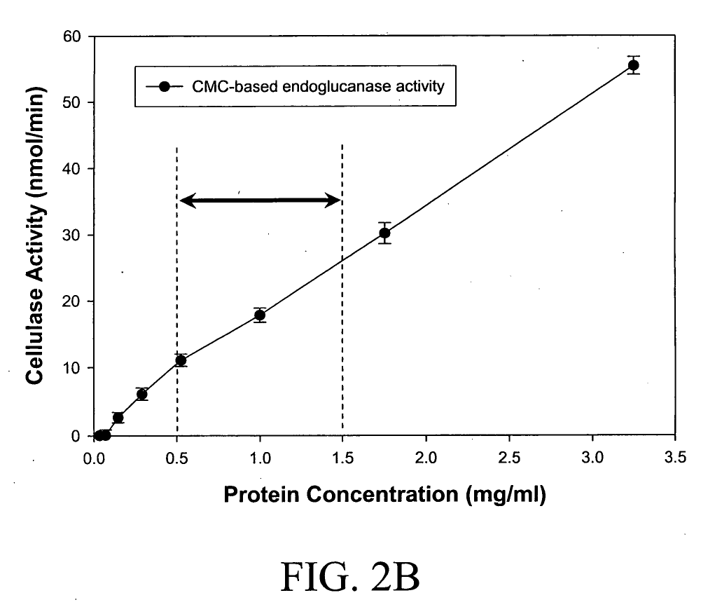

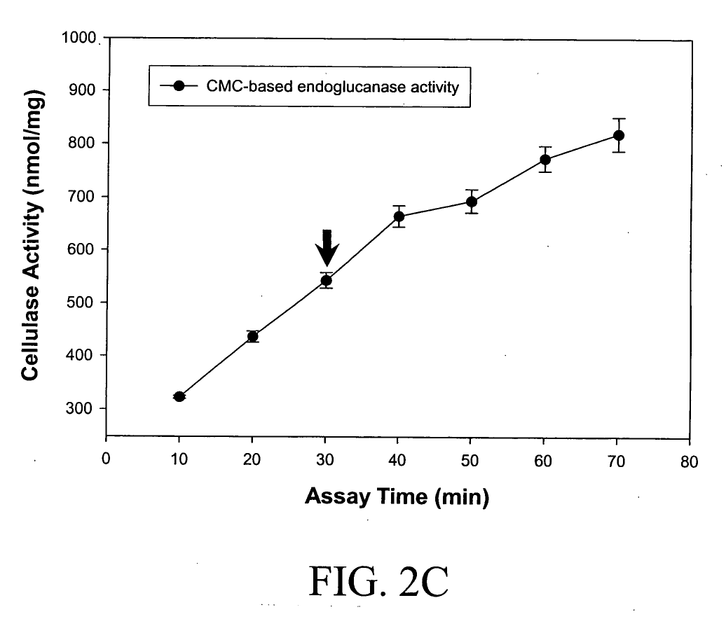

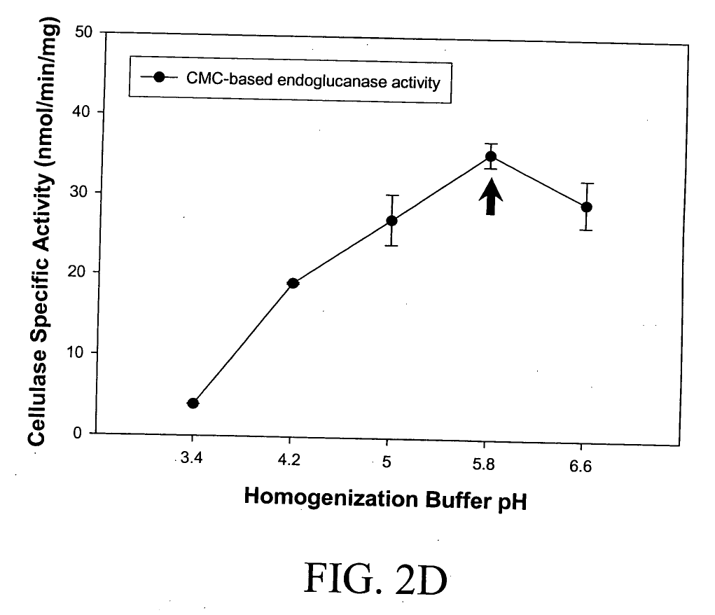

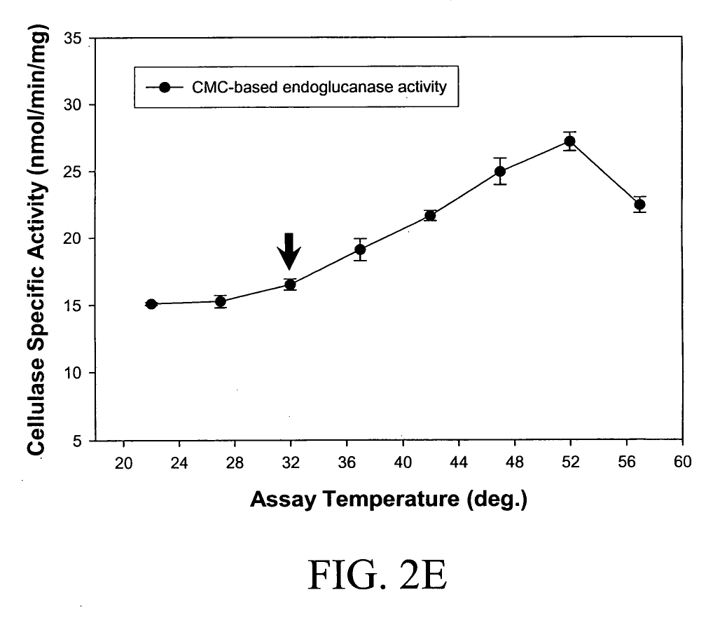

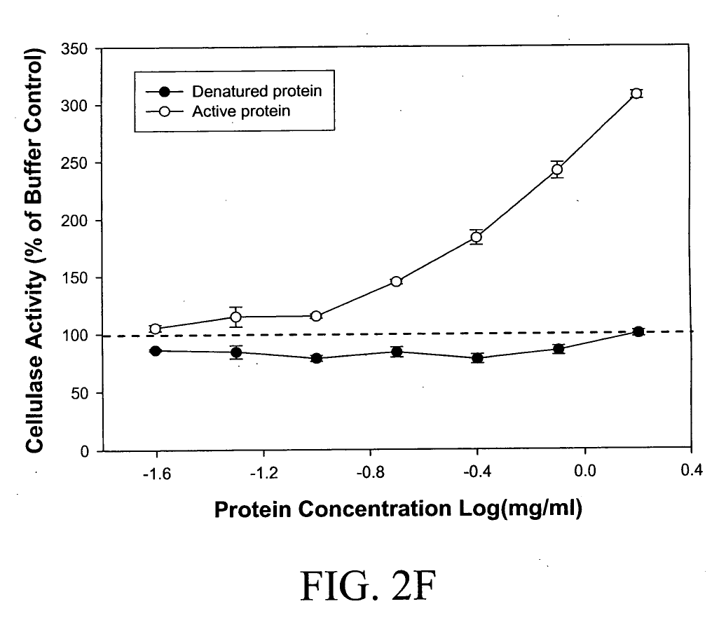

Using the materials and methods outlined above, optimal assay conditions were identified using CMC. The optimal conditions identified were substrate concentrations of CMC of approximately 0.5% (w/v) as shown in FIG. 2A; protein concentrations in the range of 0.5-1.5 mg/ml (FIG. 2B), assay times of 30 minutes (FIG. 2C), homogenization buffer pH of 5.8 (FIG. 2D) and assay temperatures of 32° C. (FIG. 2E). All these conditions were within linear activity ranges and were employed in all subsequent assays. For CMC assays, although assay temperatures between 28 and 52° C. provided linear substrate turnover, as shown in FIG. 2E, an assay temperature of 32° C. was deemed optimal because higher temperatures are excessive relative to ambient temperatures in the termite environment.

To determine if reduced cellulose present in the termite gut would interfere with the CMC assay, assays were also performed with heat-denatured protein. From this examination, no interference from competing reduced cellulose was identified, as shown in FIG. 2F.

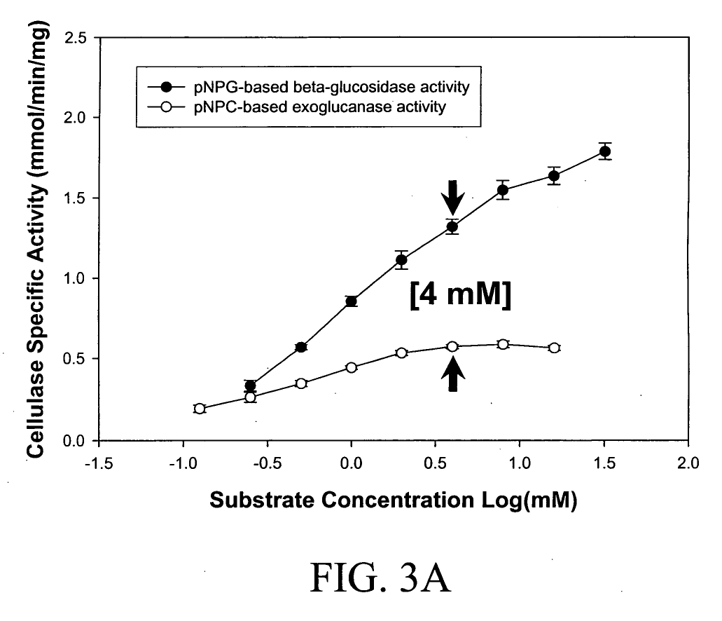

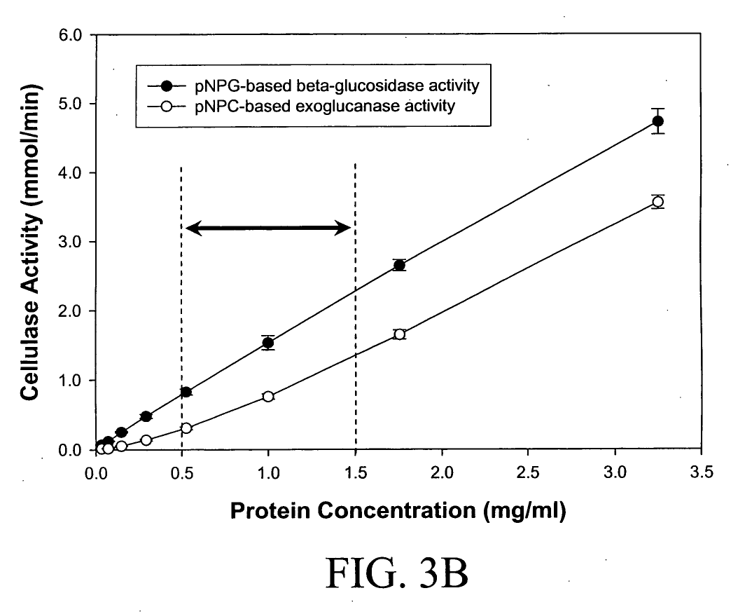

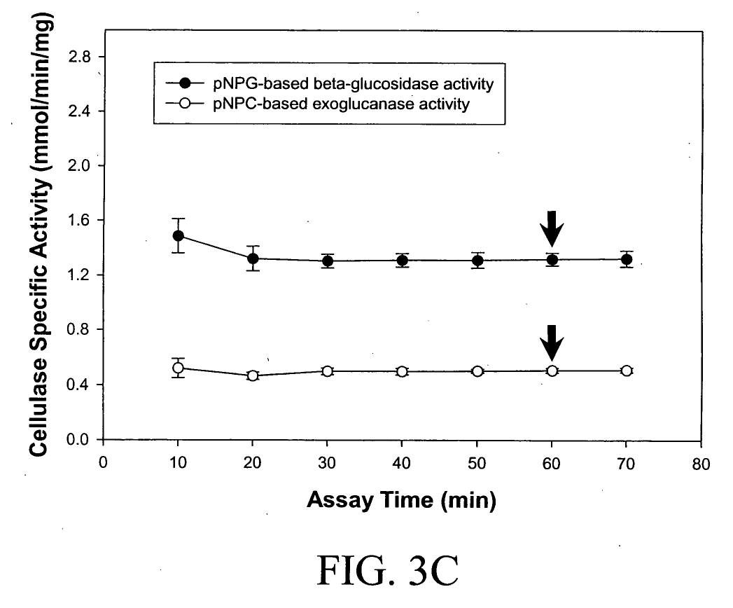

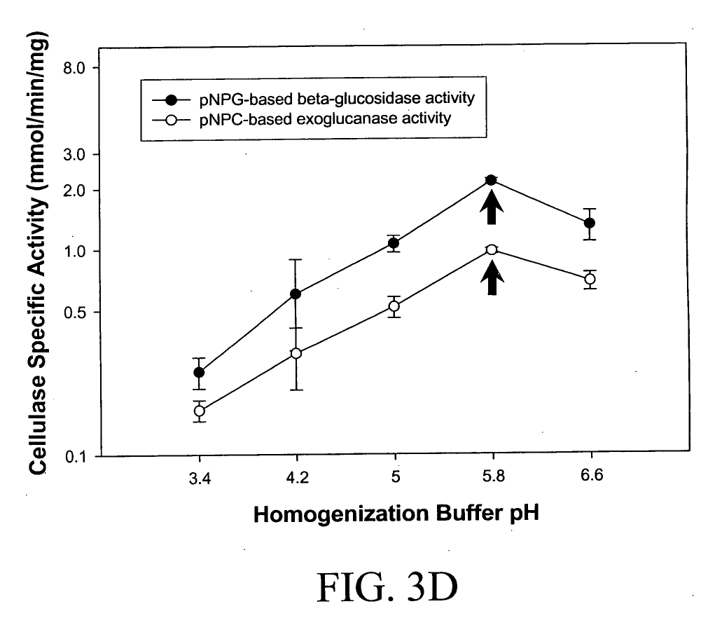

Optimal conditions identified for pNPC and pNPG assays are shown in FIGS. 3A-3D. Optimal substrate concentrations for both pNPC and pNPG are 4 mM (FIG. 3A), protein concentration for both pNPC and pNPG are in the range of approximately 0.5 to approximately 1.5 mg/ml (FIG. 3B), assay times of 60 minutes for both pNPC and pNPG (FIG. 3C), and homogenization buffer pH of 5.8 for both pNPC and pNPG (FIG. 3D). All these conditions were within linear activity ranges, as shown in FIGS. 3A-3D, and were employed in all subsequent assays.

### Cellulase Activity Among Gut Regions.

Using the optimal conditions described above, enzyme assays were used to examine cellulase activity in the three major termite gut regions of foregut+salivary gland, midgut, and hindgut as shown in Table 1 below. Data points having the same letter within a row are not significantly different by the LSD t-test (n=3; df=2; p<0.05). All ANOVAs were significant at p<0.05.

TABLE I
In Vitro Cellulase Activity and Protein Content by Gut Region

| | | | TISSUE AVERAGE (±Std. Error) | | |
|---|---|---|---|---|---|
| Activity | Assay | Data Type | Foregut | Midgut | Hindgut |
| Total Protein | Pierce BCA | μg/termite^{1.} | 9.9 (1.0) | 8.4 (0.6) | 20.4 (0.8) |
| | | RATIO | 1.2 b | 1.0 b | 2.4 a |
| Endoglucanase | CMC | nmol/min/mg^{2.} | 44.6 (6.4) | 13.0 (5.6) | 13.4 (0.2) |
| | | RATIO | 3.4 a | 1.0 b | 1.0 b |
| | | % of Total^{3.} | 39.8 (2.8) b | 8.5 (3.6) c | 51.7 (1.4) a |
| Exoglucanase | pNPC | nmol/min/mg^{2.} | 0.97 (0.24) | 0.30 (0.01) | 0.78 (0.21) |
| | | RATIO | 3.2 a | 1.0 b | 2.6 a |
| | | % of Total^{3.} | 21.3 (5.0) b | 4.9 (0.4) c | 73.8 (4.7) a |
| β-glucosidase | pNPG | nmol/min/mg^{2.} | 6.2 (0.7) | 2.8 (0.2) | 0.6 (0.1) |
| | | RATIO | 9.8 a | 4.4 b | 1.0 c |
| | | % of Total^{3.} | 56.4 (3.9) a | 18.9 (1.9) b | 24.8 (2.0) b |

^{1.}Total μg protein per termite by gut region.
^{2.}Specific activity for each substrate by gut region. Note that CMC results are in nanomole, while pNPC and pNPG are in millimoles.
^{3.}Specific activity corrected for protein by gut region, then converted to a percentage of total activity.

Relative protein content in each gut region is also shown in Table 1. These findings indicated 2× total protein content in the hindgut relative to the foregut+salivary gland and midgut, respectively, which were not significantly different. Based on specific activity in each gut region (CMC=nmol/min/mg protein; pNPC/pNPG=mmol/min/mg protein), each of the three activities are highest in the foregut+salivary gland. However, some of these activity relationships change when correcting for relative protein proportions in each gut region, which provides a more realistic assessment. When correcting for relative protein content, both the endo- and exoglucanase activity distributions change to hindgut>foregut>midgut. β-glucosidase activity, alternatively, is distributed as foregut>hindgut=midgut.

### In Vitro Enzyme Inhibition.

I₅₀s of carbohydrate-based cellulase inhibitors FMG, FMCB and CBI are summarized in FIG. 4. FIG. 4 shows that in vitro, the glucose analog FMG exhibits virtually no inhibitory properties against any of the three enzyme activities (endoglucanase (ENDO), exoglucanase (EXO) and β-glucosidase (BETA) in each gut fraction. On the other hand, the cellobiose analog FMCB showed moderate inhibition of both exoglucanase and β-glucosidase activity in both gut sections (I₅₀s in the mM range). The effects of CBI on both exoglucanase and β-glucosidase activity were most pronounced (I₅₀s in the nM-μM range). Also, I₅₀s in the foregut/salivary gland/midgut (endogenous) fraction were lower relative to the hindgut (symbiotic) section. Finally, while FMCB and CBI were effective exoglucanase and β-glucosidase inhibitors, they showed virtually no activity against endoglucanase activity in any gut section. The logical conclusion is that FMCB and CBI are effective exoglucanase and β-glucosidase inhibitors with greater specificity to endogenous termite enzymes (i.e., those in the symbiont-free foregut/midgut section). The most effective inhibitor is CBI, which shows Iso values in the nM to μM range when tested against exoglucanases and β-glucosidases. Data represent the average I₅₀± standard error (n=3 replicates, each determined in triplicate).

### Example 2

### Inhibition of Termite Cellulases Using In Vivo Feeding Bioassays

Two different termite colonies were used. A lab colony was used in bioassays that tested the effects of CBI and FMG; this was the same colony used in cellulase optimization studies, cellulase distribution studies, and for 150 determination. The other colony was a field colony, which was used to repeat the FMG assay along side FMCB. The no-choice feeding bioassay was derived from a previously-developed and slightly modified caste differentiation assay reported by M. E. Scharf, et al. in “Caste differentiation responses of two sympatric Reticulitermes termite species to juvenile hormone homologs and synthetic juvenoids in two laboratory assays.” Insectes Soc. 50 (2003) 346-354 and X. Zhou, et al. in “Social exploitation of hexamerin: RNAi reveals a major caste-regulatory factor in termites.” Proc. Nat. Acad. Sci. USA, 103 (2006) 4499-504.

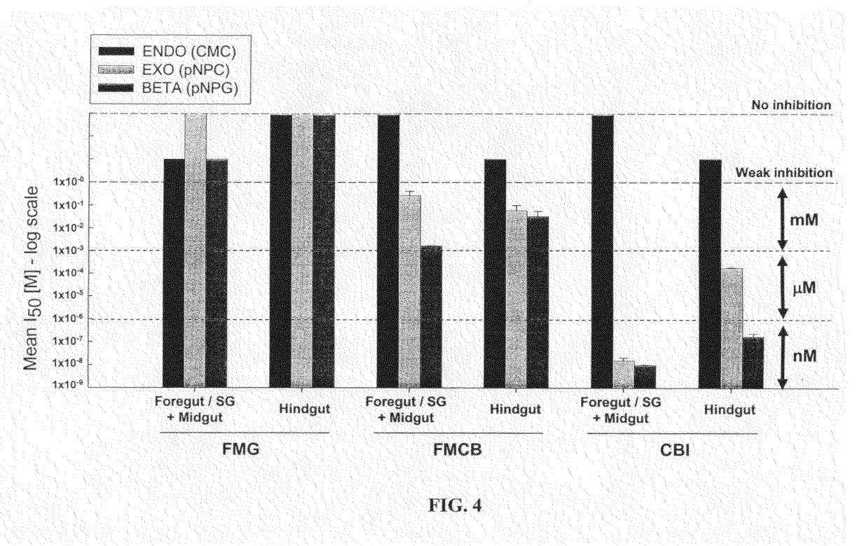

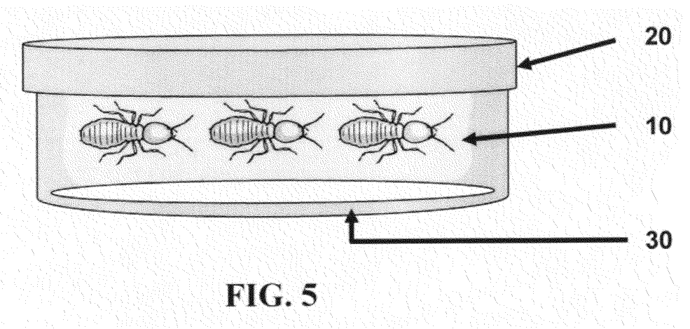

The bioassay was run by placing worker termites 10 in a Petri dish 15, as shown in FIG. 5, in groups of 15 on treated paper disks 30, commercially available from Georgia-Pacific Company. Prior to treatment, paper disks 30 were weighed. Treatments and controls were held in complete darkness at approximately 26±1° C. and 69±1% RH. The inhibitor concentrations tested were 75, 50, 25, 10, 5, 1, 0.5, and 0.1 mM (approximately 3, 2, 1, 0.4, 0.2, 0.05 and 0.1% wt/wt). For each inhibitor, paper disks were treated with 50 μl of a given concentration. Control disks received 50 μl methanol alone. Treated papers were allowed to dry in a fume hood for 30 min before placing in dishes, wetting with 25 μl water, and adding 15 termites.

Termite feeding on the filter papers was readily observable and quantifiable from the bioassays. Average feeding through the entire bioassay was summed within each replicate and calculated as a percentage of feeding relative to untreated controls, then averaged across replicates.

The experimental design consisted of three replicate dishes per concentration. All assays were carried out for a total of 24 days. Termite mortality and filter paper moisture were monitored every 4^{th} day. Every 8^{th} day, old paper disks were replaced with new ones. These new filter paper disks were treated with identical inhibitor concentrations. The removed filter paper disks 30, showing the results of termite feeding (FIG. 6), were dried and re-weighed. At the end of each assay, data were summarized as cumulative feeding per live termite and cumulative termite mortality. Data were analyzed by non-parametric t-tests (p<0.05) with commercially-available software for use in statistical analysis, designed by SAS Institute, Cary, N.C.

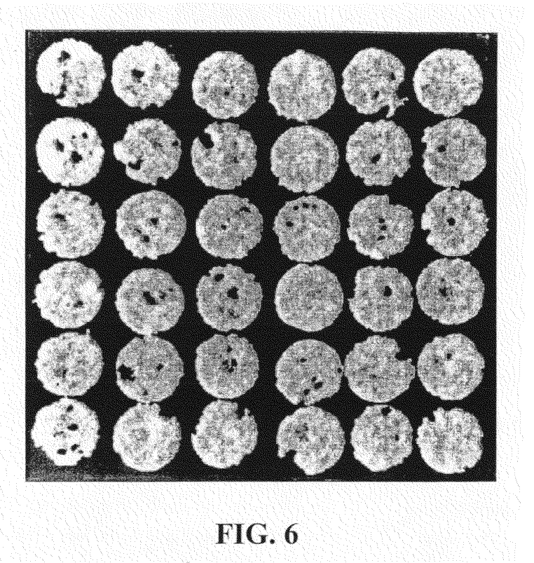

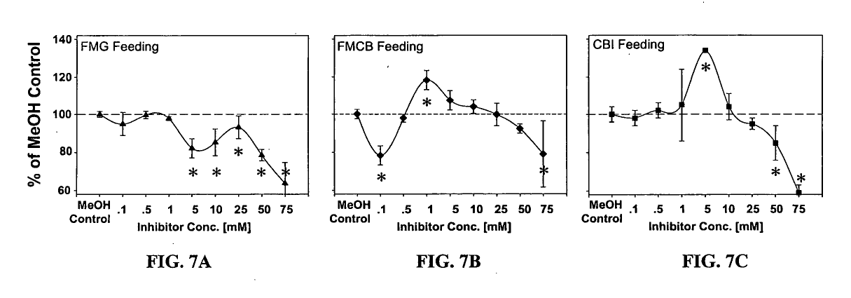

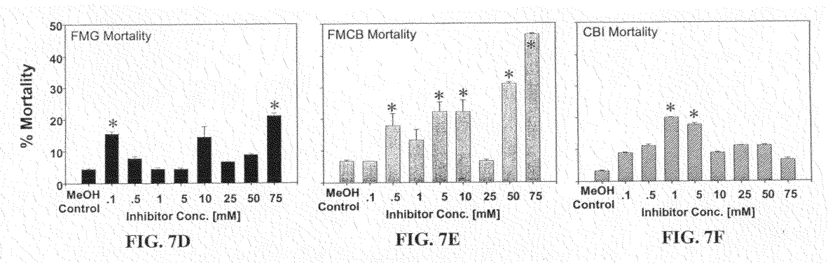

FIGS. 7A-7F provide graphic data on in vivo feeding bioassays conducted with the carbohydrate-based cellulase inhibitors to assess the impact on termite feeding and survivorship. Feeding results are expressed as the cumulative percent of untreated controls through 24 days. Mortality results are expressed as percent mortality after 24 days. Data points with asterisks (*) are significantly different from methanol-treated controls by non-parametric t-tests (p<0.05). Error bars represent standard error of the mean.

The monosaccharide inhibitor FMG did not stimulate consumption at any concentration, as shown in FIG. 7A. In contrast, the disaccharides FMCB and CBI showed both inhibitory and stimulatory effects, depending on concentration, as shown in FIGS. 7B and 7C, respectively. The inhibitory effect for CBI and FMCB occurred at the lowest and the highest concentrations while stimulatory effects occurred at midrange inhibitor concentrations.

Overall, FMCB caused greater cumulative termite mortality than CBI and FMG, as shown in FIGS. 7D-7F. Although the highest FMCB-induced mortality was associated with the highest concentrations (50 and 75 mM; 3% wt/wt), midrange concentrations also caused significant mortality, as shown in FIG. 7E. In FIG. 7D, the mortality observed in FMG assays was not entirely concentration-dependent, i.e., the highest FMG concentration only induced a maximum of approximately 20% mortality. FIG. 7F shows that CBI-induced mortality was the highest throughout the same midrange concentrations that were associated with feeding induction. Moreover, both CBI and FMCB had similar feeding stimulation results (120-130%) and mortality (˜20%) in the 1-5 mM (0.05-0.2% wt/wt) concentration ranges.

Table 2 below shows average termite feeding in CBI, FMG and FMCB bioassays. Each data point was calculated as an avg. ± std. error of three independent replicates. The column at the right summarizes normalized feeding in each experiment relative to untreated controls. FMG was tested on 2 colonies and the results averaged for presentation in FIGS. 7A-7F.

TABLE 2
Average Feeding in mg per Live Termite (std. err.)

| Test | | | | |
|---|---|---|---|---|
| Compound | | | | |
| [mM test | days | days | days | Normalized |
| conc.] | 1-8 | 9-16 | 17-24 | Avg. Totals* |
| 1st ROUND: | | | | |
| CBI [75] | 0.16 (0.01) | 0.24 (0.05) | 0.27 (0.01) | 0.59 |
| CBI [50] | 0.17 (0.03) | 0.41 (0.05) | 0.38 (0.03) | 0.85 |
| CBI [25] | 0.23 (0.01) | 0.47 (0.44) | 0.39 (0.01) | 0.95 |
| CBI [10] | 0.38 (0.05) | 0.43 (0.05) | 0.33 (0.05) | 1.03 |
| CBI [5] | 0.66 (0.05) | 0.55 (0.11) | 0.40 (0.89) | 1.34 |
| CBI [1] | 0.49 (0.12) | 0.53 (0.03) | 0.35 (0.04) | 1.05 |
| CBI [0.5] | 0.45 (0.03) | 0.51 (0.06) | 0.33 (0.04) | 1.02 |
| CBI [0.1] | 0.44 (0.04) | 0.42 (0.11) | 0.45 (0.04) | 1.98 |
| CBI [0] | 0.34 (0.02) | 0.55 (0.08) | 0.47 (0.05) | 1.00 |
| FMG [75] | 0.17 (0.03) | 0.21 (0.02) | 0.28 (0.02) | 0.67 |
| FMG [50] | 0.30 (0.01) | 0.34 (0.01) | 0.34 (0.02) | 0.99 |
| FMG [25] | 0.27 (0.04) | 0.22 (0.05) | 0.34 (0.02) | 0.83 |
| FMG [10] | 0.32 (0.07) | 0.38 (0.09) | 0.41 (0.05) | 0.93 |
| FMG [5] | 0.39 (0.06) | 0.58 (0.07) | 0.39 (0.07) | 0.72 |
| FMG [1] | 0.55 (0.02) | 0.58 (0.03) | 0.51 (0.03) | 0.92 |
| FMG [0.5] | 0.57 (0.08) | 0.54 (0.07) | 0.44 (0.07) | 0.96 |
| FMG [0.1] | 0.52 (0.03) | 0.48 (0.10) | 0.45 (0.04) | 0.98 |
| FMG [0] | 0.36 (0.03) | 0.42 (0.04) | 0.44 (0.04) | 1.00 |
| 2nd ROUND 2: | | | | |
| FMCB [75] | 0.27 (0.04) | 0.41 (0.13) | 0.19 (0.08) | 0.79 |
| FMCB [50] | 0.41 (0.02) | 0.32 (0.03) | 0.29 (0.04) | 0.92 |
| FMCB [25] | 0.40 (0.03) | 0.35 (0.06) | 0.35 (0.02) | 1.00 |
| FMCB [10] | 0.33 (0.02) | 0.38 (0.05) | 0.44 (0.03) | 1.04 |
| FMCB [5] | 0.42 (0.33) | 0.37 (0.02) | 0.39 (0.04) | 1.07 |
| FMCB [1] | 0.37 (0.03) | 0.44 (0.03) | 0.49 (0.02) | 1.18 |
| FMCB [0.5] | 0.31 (0.00) | 0.36 (0.01) | 0.41 (0.02) | 0.98 |
| FMCB [0.1] | 0.27 (0.00) | 0.27 (0.00) | 0.32 (0.05) | 0.78 |
| FMCB [0] | 0.27 (0.03) | 0.37 (0.04) | 0.46 (0.04) | 1.00 |
| FMG [75] | 0.21 (0.03) | 0.19 (0.07) | 0.27 (0.05) | 0.60 |
| FMG [50] | 0.25 (0.02) | 0.28 (0.03) | 0.29 (0.01) | 0.74 |
| FMG [25] | 0.25 (0.04) | 0.31 (0.05) | 0.40 (0.02) | 0.87 |
| FMG [10] | 0.17 (0.02) | 0.25 (0.02) | 0.45 (0.04) | 0.79 |
| FMG [5] | 0.29 (0.02) | 0.29 (0.03) | 0.43 (0.05) | 0.92 |
| FMG [1] | 0.36 (0.04) | 0.38 (0.01) | 0.39 (0.06) | 1.04 |
| FMG [0.5] | 0.34 (0.01) | 0.34 (0.03) | 0.47 (0.03) | 1.03 |
| FMG [0.1] | 0.20 (0.04) | 0.33 (0.05) | 0.48 (0.07) | 0.92 |
| FMG [0] | 0.27 (0.03) | 0.37 (0.04) | 0.46 (0.04) | 1.00 |

*Data presented in FIGS. 7A-7C; determined as the average of each replicate in relation to the control [0] average in each experiment.

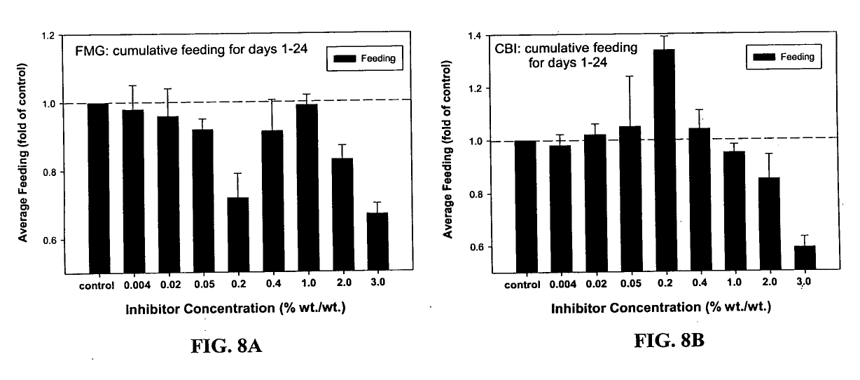

FIG. 8A confirms that the monosaccharide inhibitor FMG had little stimulatory effects at any concentration. The disaccharide inhibitor CBI, however, was either inhibitory or stimulatory to feeding, depending on concentration, as shown in FIG. 8B. The conclusion that FMG is inhibitory while CBI is stimulatory is based on the fact that FMG feeding never exceeded that of the untreated control, while CBI feeding did at some concentrations. The optimal concentrations that stimulated feeding for CBI were 0.05% through 0.4% wt/wt as shown in FIG. 8B. Thus, FIGS. 8A and 8B show that the disaccharide-based inhibitors CBI and FMCB both elicit feeding stimulation and cause termite mortality; whereas, the mono-saccharide-based inhibitor, FMG does not elicit significant feeding stimulation and consequently results in lower percentages of mortality.

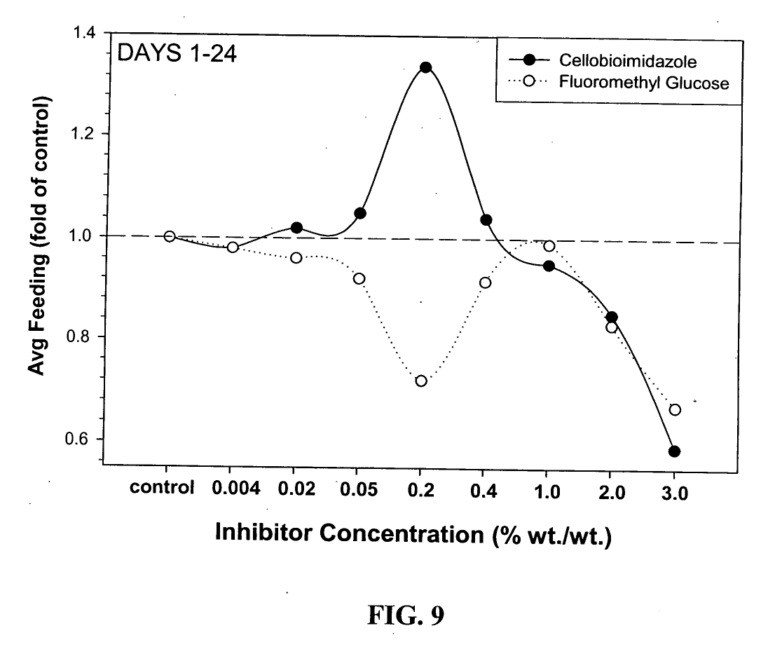

When plotting the feeding responses for FMG vs. CBI on the same graphic scale, there is a remarkable mirror-image feeding pattern associated with concentrations below 1% wt/wt (FIG. 9). The cause of this relationship is unknown at the present time. One explanation is that the mono- and disaccharide nature of the two inhibitors may differentially impact feeding behavior. Alternatively, the increased intake of CBI in the 0.02-0.4% range may be the result of cellulase inhibition. In other words, cellulase inhibition may limit nutrient availability, thus making the termites more “hungry,” which subsequently induces greater feeding.

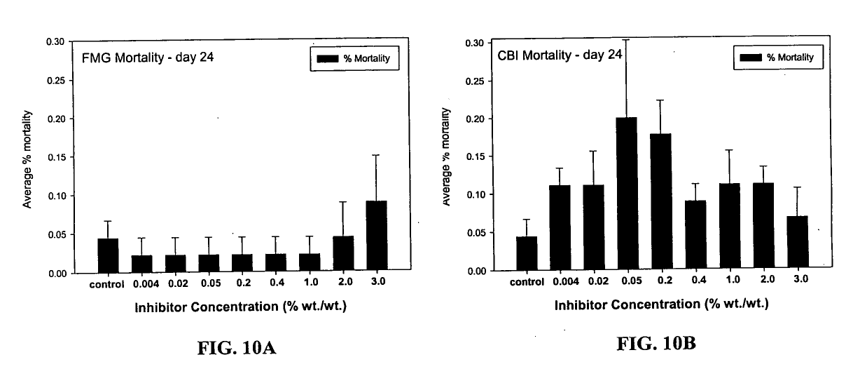

FIGS. 10A and 10B are graphs of the mortality of FMG and CBI, respectively. The mortality caused by CBI and shown in FIG. 10B is substantially greater than the mortality caused by FMG and shown in FIG. 10A. Moreover, CBI-induced mortality was most pronounced within the concentration range that was associated with feeding induction (0.05-0.2% wt/wt). The highest mortality observed was around 20% for the 0.05 and 0.2% CBI concentrations; although, one replicate of the 0.05% concentration had over 30% mortality. There was more of a concentration-dependent mortality effect with FMG, but it only reached a maximum of 10% at the highest concentration tested. It is possible that greater mortality could be observed for both CBI and FMG in longer bioassays that use more termites per dish, or which use field colonies that are more nutritionally and/or physiologically stressed.

In Table 3 below, examples of (A) known cellulase inhibitors and (B) conventional termiticides are shown that can be used as bait active ingredients in combination with the novel use of CBI and FMCB as feeding stimulants.

TABLE 3
CBI and FMCB as Feeding Stimulants

| | | |
|---|---|---|
| Mode of Action | Target Site | Insecticides |

(A)

| | | |
|---|---|---|
| Cellulase Inhibitor | Endoglucanase | Xyloglucan endoglucanase inhibitor protein, |
| | | Glucanase inhibitor protein, Nectarin IV, |
| | | Endoglucanase-targeted double-stranded |
| | | RNA |
| | Cellobiohydrolase | Cellobiono-hydroximolactam, Cellobio- |
| | | phenylcarbamate, N-linked cellotriosides, |
| | | glucoimidazole, phenyl-substituted |
| | | glucoimidazole, thio-oligosaccharides, imino- |
| | | disaccharides, tetrahydro-oxazines, |
| | β-glucosidase | Conduritol B Epoxide, 1-Deoxynojirimycin, |
| | | Gluconolactone |

(B)

| | | |
|---|---|---|
| Neurotoxin | Chloride Channel | Fipronil, Fipronil Sulfone, Ethioprole, |
| | | Abamectin, Emamectin |
| | Sodium Channel | Bifenthrin, Indoxacarb, Metaflumizone |
| | Acetylcholine Receptor | Imidacloprid, Clothianidin, Thiacloprid, |
| | | Nitenpyram, Spinosyn, Spinetoram, |
| | | Dinotefuran, Nithiazine, Acetamiprid |
| | Octopamine Receptor | Chlordimeform, Amitraz, Formetanate, |
| | | Formparanate |
| | Acetylcholinesterase | Carbaryl |
| | Calcium Channel | Chlorantraniliprole, Flubendiamide |
| Respiratory Inhibitor | Mitochondria | Hydramethylnon, Sulfluramid, Chlorfenapyr, |
| | | Pyrimidifen, Diafenthiuron, Pyridaben, Boric |
| | | Acid |
| Growth Regulator | Chitin Synthesis | Hexaflumuron, Noviflumuron, Diflubenzuron, |
| | | Cyromazine, Lufenuron, Novaluron, |
| | | Teflubenzuron, Novaluron |
| | Juvenile Hormone Receptor | Methoprene, Fenoxycarb, Epofenonane, |
| | | Hydroprene, Kinoprene, Juvenogens, |
| | | Triprene, Pyriproxyfen |
| | Juvenile Hormone Synthesis | Precocene I, II or III |
| | (Corpora allata gland) | |
| | Ecdysone Receptor | Chromofenozide, Halofenozide, |
| | | Methoxyfenozide, Tebufenozide, |
| | | Azadirachtin |
| | Termite Primer Pheromones | Cadinene, Cadinene Aldehyde, Geranyl- |
| | | Linalool, Geranyl-Geraniol, Humulene, |
| | | Farnesene, Farnesol, Pinene, Limonene |
| Gut Disruption | Gut Proteins/Tissue | Bacillus thuringiensis endotoxins, |
| | | L-methionine, Boric Acid, DSOBTH |

Table 3 demonstrates that feeding stimulants CBI and FMCB can be used with other termiticides. As discussed above, CBI and FMCB have a unique application as feeding stimulants and can be used alone as feeding stimulants to affect the feeding rate of termites to such an extent as to cause termite mortality.

### Example 3

### Post-Feeding Inhibition of Termite Cellulase

Endoglucanase, exoglucanase and β-glucosidase activities were further examined in pooled homogenates of whole termites alive at day 24 in the feeding bioassays. The goal of these experiments was to determine if there is agreement between inhibition observed in in vitro enzyme assays, feeding and mortality impacts after in vivo feeding bioassays.

From these termites, whole-body homogenates were prepared as described in a preceding section of in vitro analysis where the whole body homogenates are centrifuged and passed though glass wool to remove excess lipids before proceeding with cellulase activity assays. Using enzyme assay procedures as described above, the percentage inhibition of endoglucanase, exoglucanase and β-glucosidase activity were determined relative to methanol-treated controls.

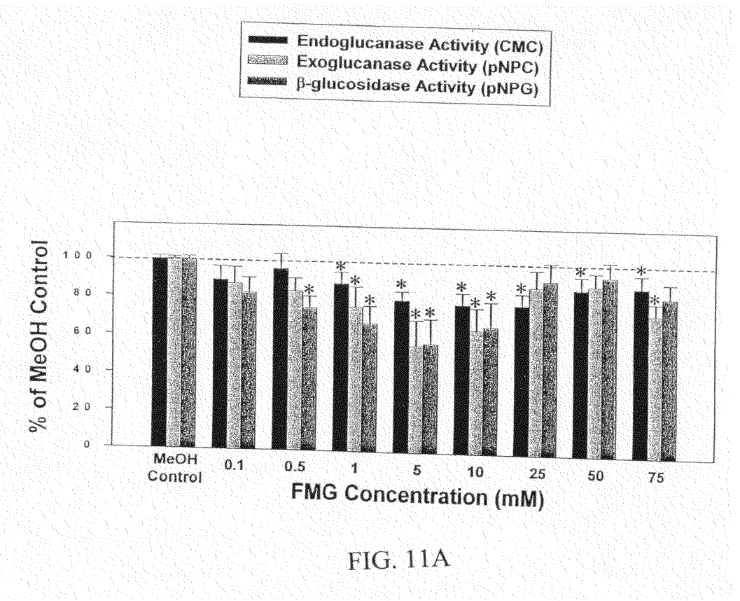

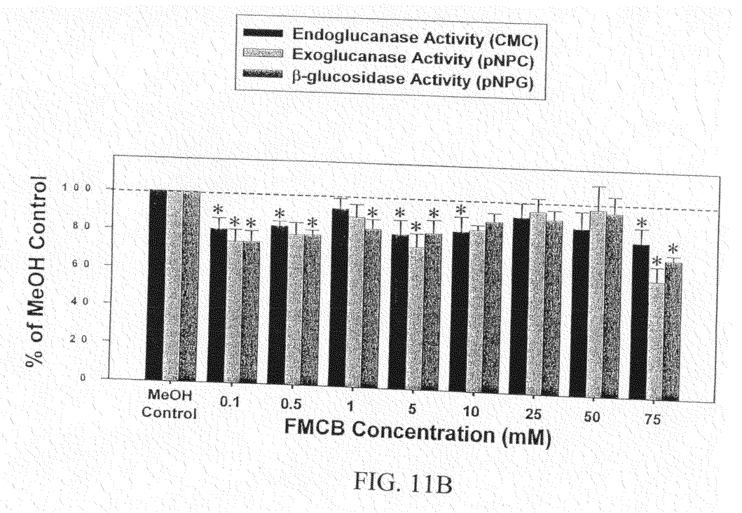

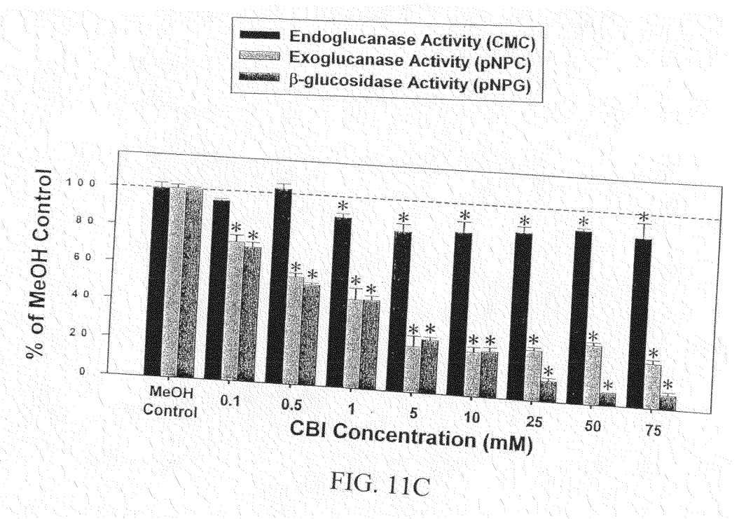

FIGS. 11A-11C show the inhibition of ENDO, EXO AND BETA cellulase activity in individuals surviving feeding bioassays using various concentrations of FMG, FMCB and CBI. Data represents the percentage of remaining activity relative to methanol (MeOH)-treated controls. The three enzyme activities examined were endoglucanase (substrate=CMC), exoglucanase (substrate=pNPC) and β-glucosidase (substrate=pNPG). Data points with asterisks (*) are significantly different from methanol-treated controls by non-parametric t-tests (p<0.05). Error bars represent standard error of the mean.

The impact of CBI on all three cellulase activities after feeding were significant, as shown in FIG. 11C and in good agreement with in vitro inhibition (150) results. In particular, with CBI there was a pronounced concentration-dependent pattern of inhibition for both exoglucanase and β-glucosidase activity. Exoglucanase activity was maximally inhibited by CBI at 5 mM and above (˜75% reduction relative to controls), while β-glucosidase inhibition reached maximal levels at 25 mM and above (˜90% reduction relative to controls).

Contrary to some of the in vitro inhibition (I₅₀) results, FIGS. 11A and 11B show that FMG and FMCB resulted in a statistically significant reduction in all three cellulase activities after feeding. In particular, endoglucanase activity was not inhibited under in vitro conditions, but it was significantly impacted in the feeding bioassays. Although statistically significant in some cases, FMG and FMCB impacts on the three cellulase activities after feeding were not biologically substantial (≦40% reduction relative to controls). Also, interestingly, the concentration-dependent enzyme inhibition patterns for FMG very closely resembled the concentration-dependent patterns of feeding inhibition in FMG feeding bioassays.

### Example 4

### Validative Bioassays with Mono- and Di-Saccharides

To better define the effects of the carbohydrate-based cellulase inhibitors, feeding bioassays were conducted using only the mono and disaccharides glucose, maltose and cellobiose. These sugars were chosen because glucose is a monosaccharide similar to FMG, while maltose and cellobiose are alpha and beta-linked sugars (respectively) similar to both FMCB and CBI. The sugar feeding bioassays were carried out in an identical manner to the no-choice inhibitor feeding assays described above. However, due to solubility differences, the mono- and disaccharides were dissolved in water instead of methanol, and also, controls received water-treated disks rather than methanol.

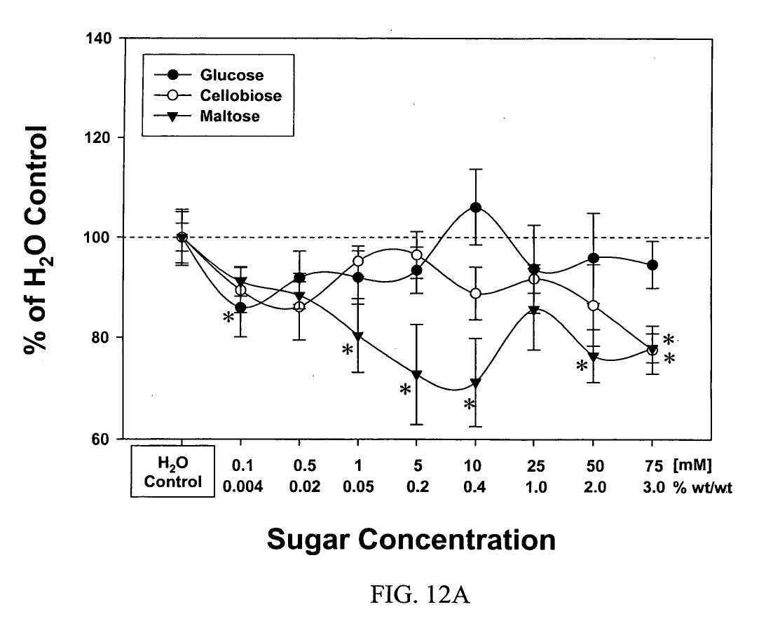

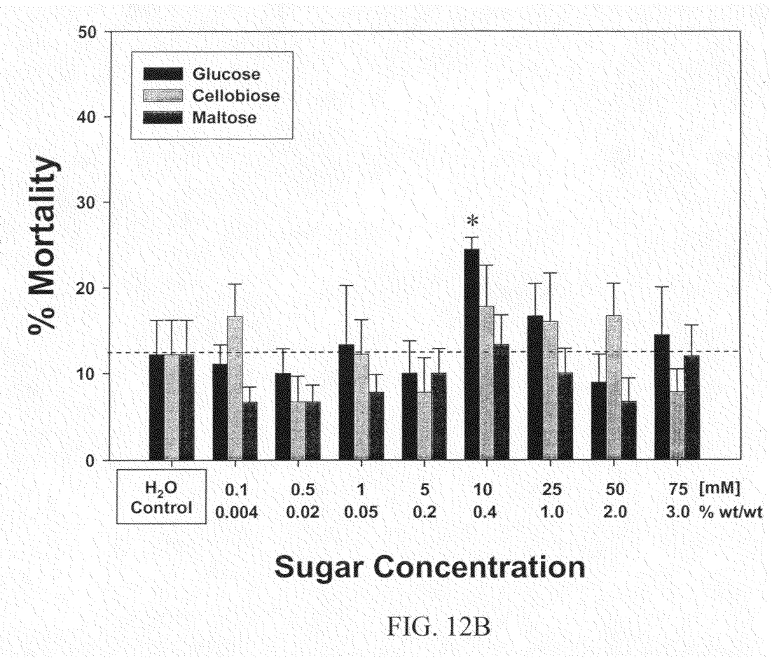

FIG. 12A shows that none of the mono- and disaccharides (glucose, cellobiose or maltose) stimulated feeding as did the carbohydrate-based inhibitors FMCB and CBI. In fact, FIG. 12A shows that maltose is generally a feeding deterrent at the concentrations tested (0.004-3.0% wt/wt). Further, when examining bioassay mortality, none of the mono- and disaccharides showed impacts that resembled mortality induced by FMG, FMCB or CBI, as shown in FIG. 12B. Cellobiose and maltose are identical in structure, except that maltose is an α-linked sugar, while cellobiose is β-linked. Data points with asterisks (*) are significantly different from untreated controls by non-parametric t-tests (p<0.05). Error bars represent standard error of the mean. Thus, the feeding impacts and mortality observed in association with the carbohydrate-based cellulase inhibitors of the present invention are attributable to the unique chemistry of the inhibitors themselves, and are not a generalized response to carbohydrates.

Using choice tests, Swoboda et al. in “The effects of nutrient compounds (sugars and amino acids) on bait consumption by Reticulitermes spp.” Sociobiology 44 (2004) 547-563 observed that Reticulitermes termites consumed significantly more sugar-treated than untreated paper substrates. Also, when using no-choice assays, Swoboda et al. found that consumption rates were identical between sugar treatments and untreated controls. Similarly, in no-choice tests of the present invention, no significant feeding stimulation was observed for the monosaccaride glucose, the alpha-linked disaccharide maltose and the beta-linked disaccharide cellobiose. Alternatively, it was observed that the two carbohydrate-based inhibitors FMCB and CBI elicited feeding stimulation. Therefore, it is clear that phagostimulation associated with FMCB and CBI is not the result of the carbohydrate nature of these compounds. Rather, this feeding stimulation, found only at some mid-range concentrations, must be attributable to the unique functional groups on FMCB and CBI and the inhibitory characteristics conferred by them.

The most plausible explanation for the observed feeding stimulation is that compensatory feeding is occurring in response to nutritional deprivation from cellulase inhibition. However, with respect to compensatory feeding, another possible cause is that it results from symbiont mortality and affiliated nutritional deprivation. Also, another possible explanation is that feeding stimulation results from pharmacological interactions by the inhibitors with termite chemosensory receptors, as discussed by J. I. Glendinning, et al. in “How do Inositol and Glucose Modulate Feeding in Manduca sexta Caterpillars? J. Exp. Biol. 203 (2000) 1299-1315.

### Example 5

### Cellulase Inhibition Susceptibility by Small Body and Large Body Termite Colonies

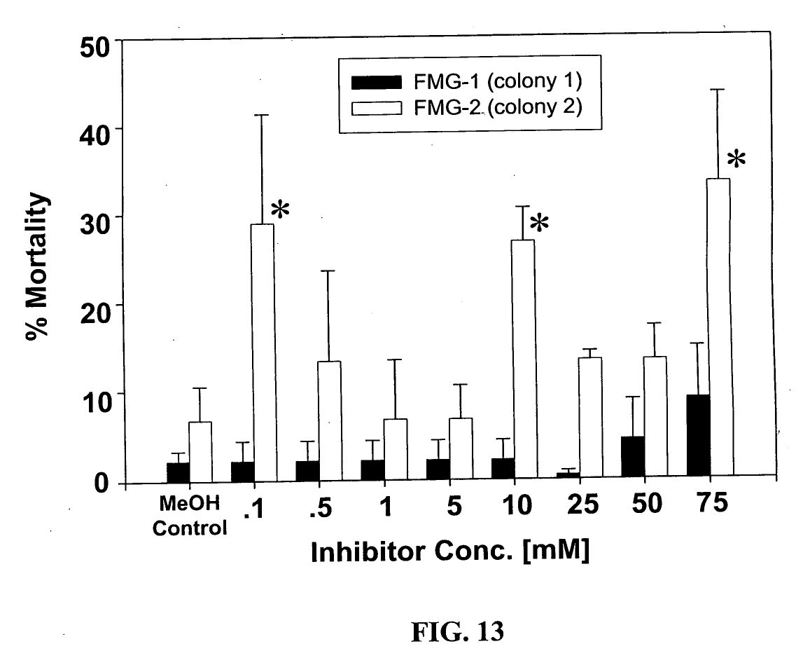

Lab and field colonies were tested for mortality using the experimental feeding conditions in Example 3, using the monosaccharide-based inhibitor, FMG. FIG. 13 shows differing degrees of susceptibility to FMG. The nutritionally stressed field colonies with smaller bodies are more sensitive to the effects of cellulase inhibition, than the larger bodied lab colony termites. In other words, susceptibility apparently correlates with nutritional status, i.e., field colonies apparently have less nutritional reserves and are more susceptible to cellulase inhibitors. Results of the present studies also indicate that inhibitor concentrations in the range of 1-10 mM (0.05-0.4% wt/wt) will suffice for evaluations of inhibitor compounds.

An important trend also noted by Zhu et al. in J. Econ. Entomol. 98 (2005), supra was that the two colonies studied by Zhu et al, one with small- and one with large-bodied individuals, showed differing susceptibility and inhibition. In particular, Zhu et al. observed that the larger workers were more tolerant of inhibition effects and required longer starvation periods to induce feeding. Similarly, FIG. 13 confirms that in two different colonies treated with FMG, in the present invention, a laboratory-reared colony with more prominent fat reserves was less affected than a leaner field-collected colony with up to approximately 30% mortality for the field colony termites and approximately 2-3% mortality for the lab colony termites. These observations highlight a potentially important tradeoff between nutritional status and susceptibility to cellulase inhibitors.

Even more effective analogs of inhibitors CBI and FMCB (for example, with longer cellulose chains) are prepared to increase termite mortality. An old adage says, “What one eats can kill one.” For the termite, the novel carbohydrate-based cellulase inhibitors of the present invention will do just that.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A carbohydrate-based cellulase inhibitor composition comprising:
mono-saccharide sugars in an amount effective to affect feeding rates in termites.

2. The carbohydrate-based cellulase inhibitor composition of claim 1, wherein the mono-saccharide sugars are selected from the group consisting of fluoro-methyl-glucose (FMG), mono-fluoro glucose, and di-fluoro glucose.

3. The carbohydrate-based cellulase inhibitor of claim 2, wherein the effective amount of fluoro-methyl-glucose (FMG) is in a concentration above approximately 1 mM to inhibit feeding and cause significant termite mortality at the lowest and highest concentrations.

4. A carbohydrate-based cellulase inhibitor composition comprising:
di-saccharide sugars in an amount effective to affect feeding rates in termites.

5. The carbohydrate-based cellulase inhibitor composition of claim 4, wherein the di-saccharide sugars are selected from the group consisting of fluoro-methyl cellobiose (FMCB), cello-bio-imidazole (CBI), and cellobio-dintrophenol.

6. The carbohydrate-based cellulase inhibitor composition of claim 5, wherein the effective amount of cello-bio-imidazole (CBI) is in a range between approximately 1 mM to approximately 10 mM to cause sufficient feeding stimulation of termites to result in termite mortality.

7. The carbohydrate-based cellulase inhibitor composition of claim 5, wherein the effective amount of fluoro-methyl cello biose (FMCB) is in a range between approximately 1 mM to approximately 10 mM to cause sufficient feeding stimulation of termites to result in termite mortality.

8. An environmentally non-toxic termite bait system comprising:
mono-saccharide sugars in an amount effective to affect feeding rates in termites.

9. The environmentally non-toxic termite bait system of claim 8, wherein the mono-saccharide sugars are selected from the group consisting of fluoro-methyl-glucose (FMG), mono-fluoro glucose, and di-fluoro glucose.

10. The environmentally non-toxic termite bait system of claim 9, wherein the effective amount of fluoro-methyl-glucose (FMG) is in a concentration above approximately 1 mM to inhibit feeding and cause significant termite mortality at the lowest and highest concentrations.

11. An environmentally non-toxic termite bait system comprising:
di-saccharide sugars that affect feeding rates in termites.

12. The environmentally non-toxic termite bait system of claim 11, wherein the di-saccharide sugars are selected from the group consisting of fluoro-methyl cello biose (FMCB), cello-bio-imidazole (CBI), and cellobiose-dintrophenol (cellobio-DNP).

13. The environmentally non-toxic termite bait system of claim 12, wherein the effective amount of cello-bio-imidazole (CBI) is in a range between approximately 1 mM to approximately 10 mM to cause sufficient feeding stimulation of termites to result in termite mortality.

14. The environmentally non-toxic termite bait system of claim 12, wherein the effective amount of fluoro-methyl cello biose (FMCB) is in a range between approximately 1 mM to approximately 10 mM to cause sufficient feeding stimulation of termites to result in termite mortality.

15. An termite bait composition that is non-toxic to the environment comprising:
a single carbohydrate-based compound used as a termiticide and a cellulase inhibitor and as a feeding stimulant, wherein no separate materials are used with the compound.

16. The carbohydrate-based compound of claim 15, wherein the compound is an analog of at least one of fluoro-methyl-glucose (FMG), mono-fluoro glucose, di-fluoro glucose, fluoro-methyl cellobiose (FMCB), cello-bio-imidazole (CBI), and cellobio-dintrophenol.

17. The carbohydrate-based compound of claim 16, wherein the compound is used in an amount that is in a range between approximately 1 mM to approximately 10 mM to result in termite mortality.

18. The carbohydrate-based compound of claim 16 wherein the analog consists of a long cellulose chain.

19. The carbohydrate-based compound of claim 18, wherein the long cellulose chain includes β-glycosidic chain lengths.

20. A method for controlling termites by both inhibiting cellulose digestion and stimulating termite feeding, comprising the steps of:
selecting a termite food source having an effective amount of a composition consisting of a single mono-saccharide sugar compound selected from the group consisting of fluoro-methyl-glucose (FMG), mono-fluoro glucose, and di-fluoro glucose;
baiting termites with the selected termite food source;
stimulating termite feeding solely with the selected termite food source; and
inhibiting cellulase digestion of the termites solely with the selected termite food source, wherein the selected termite food source is used for controlling the termites.

21. The method of claim 20, wherein the baiting step includes the step of:
incorporating the selected termite food source as the sole termiticide in a termite bait station.

22. The method of claim 21, wherein the selected termite food source is in a range between approximately 1 mM to approximately 10 mM.
